(19) United States
(12) Patent Application Publication
(10) Pub. No.: US 2014/0195596 A1
(43) Pub. Date: Jul. 10, 2014

(54) COMMUNICATION EQUIPMENT AND COMMUNICATION CONTROL METHOD

(71) Applicant: FUJITSU LIMITED, Kawasaki-shi (JP)

(72) Inventors: Koichi YAMASAKI, Kawasaki (JP); Kazuki MATSUI, Kawasaki (JP)

(73) Assignee: FUJITSU LIMITED, Kawasaki-shi (JP)

(21) Appl. No.: 14/084,125

(22) Filed: Nov. 19, 2013

(30) Foreign Application Priority Data
Jan. 7, 2013 (JP) 2013-000468

(51) Int. Cl. H04L 29/06

(52) U.S. Cl. CPC H04L 67/42
USPC 709/203

(57) ABSTRACT

Communication equipment, arranged between a terminal device and a server, includes: a detector configured to detect transmitted data that is transmitted to the terminal device and non-transmitted data that is not transmitted to the terminal device, from service data transmitted from the server to the terminal device through the communication equipment; a first calculator configured to calculate a first cost of transmitting the non-transmitted data to the terminal device; a second calculator configured to calculate a second cost of transmitting, to the terminal device, a difference image between an image corresponding to the service data and an image corresponding to the transmitted data; and a transmission scheme decision unit configured to transmit the non-transmitted data to the terminal device when the second cost is greater than the first cost and transmit the difference image to the terminal device when the second cost is smaller than the first cost.

### CROSS-REFERENCE TO RELATED APPLICATION

This application is based upon and claims the benefit of priority of the prior Japanese Patent Application No. 2013-000468, filed on Jan. 7, 2013, the entire contents of which are incorporated herein by reference.

### FIELD

The embodiments discussed herein are related to communication equipment and a communication control method.

### BACKGROUND

Communication systems are speeded up in recent years, and terminal devices for using services provided from Web servers are widely available. Examples of the high-speed communication systems in practical use include LTE (Long Term Evolution), WiMAX (Worldwide Interoperability for Microwave Access), and public wireless LAN. Terminal devices, such as smartphones and tablets, are also widely used. As a result, BYOD (Bring Your Own Device) is in widespread use.

An example of a related technique includes a thin client system that secures high operability while ensuring the security. In the thin client system, a program operated on a thin client may be selected according to the network quality between the thin client and a thin client server (for example, Japanese Laid-Open Patent Publication No. 2012-99091).

Other related techniques are described, for example, in Japanese Laid-Open Patent Publications No. 2001-211443, No. 2009-271576, and No. 2010-182176.

Some applications provided by Web services are executed a terminal device, instead of Web servers. For example, terminal devices execute Java Applet (registered trademark) and Java Script (registered trademark). Therefore, if the performance of the CPU of a terminal device is low for example, or if the memory capacity of the terminal device is small, the terminal device may not be able to execute the applications at a desired response.

This problem may be solved by providing gateway equipment between the Web server and the terminal device, for example. In this case, the gateway equipment executes the applications to generate images to be displayed on the terminal device and transmits the image data to the terminal device. However, such a system configuration may lead to insufficient resources in the gateway equipment when a large number of terminal devices exist under the gateway equipment. When the resources of the gateway equipment become insufficient, the process slows down, or the process cannot be executed. As a result, the response of service is reduced in each terminal device. For example, the time from the request of a service by a user to the display of a screen image corresponding to the service increases.

### SUMMARY

According to an aspect of the embodiments, communication equipment, arranged between a terminal device and a server, includes: a detector configured to detect transmitted data that is transmitted from the communication equipment to the terminal device and non-transmitted data that is not transmitted from the communication equipment to the terminal device, from service data transmitted from the server to the terminal device through the communication equipment; a first calculator configured to calculate a first cost of transmitting the non-transmitted data to the terminal device; a second calculator configured to calculate a second cost of transmitting, to the terminal device, a difference image between an image corresponding to the service data and an image corresponding to the transmitted data; and a transmission scheme decision unit configured to transmit the non-transmitted data to the terminal device when the second cost is equal to or greater than the first cost and transmit the difference image to the terminal device when the second cost is smaller than the first cost.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration of a Web system according to an embodiment;

FIGS. 2A and 2B illustrate an outline of a communication control method of the embodiment;

FIG. 3 illustrates hardware configurations of a terminal device, a server, and a gateway;

FIG. 4 is a diagram illustrating functions of the terminal device, the gateway, and the server;

FIG. 5 is a flow chart illustrating the communication control method of the embodiment;

FIG. 6A illustrates an example of service data received by the gateway;

FIG. 6B illustrates an example of transmitted data;

FIG. 7 illustrates an example of control information;

FIG. 8 illustrates an example of execution decision information;

FIG. 9 is a diagram illustrating a process of generating non-displayed region image;

FIG. 10 illustrates an example of data size of the non-displayed region image;

FIG. 11 is a diagram illustrating a method of generating an image of a remote connection screen;

FIG. 12 is a flow chart illustrating a process of a control information transmitter;

FIG. 13 is a flow chart illustrating a process of a control information receiver;

FIG. 14 is a flow chart illustrating a process of an execution decision unit;

FIG. 15 is a flow chart illustrating a process of a Web browser of the gateway;

FIG. 16 is a flow chart illustrating a process of a transmission scheme decision unit;

FIG. 17 is a flow chart illustrating a process of a non-displayed region detector;

FIG. 18 is a flow chart illustrating a process of a data transmitter;

FIG. 19 is a flow chart illustrating a process of a screen selector;

FIG. 20 is a flow chart illustrating a process of a remote connection screen configuration unit;

FIG. 21 is a diagram illustrating functions of the terminal device, the gateway, and the server according to a first embodiment;

FIGS. 22A and 22B illustrate an example of HTML files;

FIG. 23 is a flow chart illustrating a process of the Web browser of the gateway of the first embodiment;

FIG. 24 is a flow chart illustrating a process of the HTML analyzer;

FIG. 25 is a flow chart illustrating a process of the execution decision unit in the first embodiment;

FIG. 26 illustrates an example of the execution decision information used in a second embodiment; and

FIG. 27 is a diagram illustrating functions of the terminal device, the gateway, and the server according to a third embodiment.

### DESCRIPTION OF EMBODIMENTS

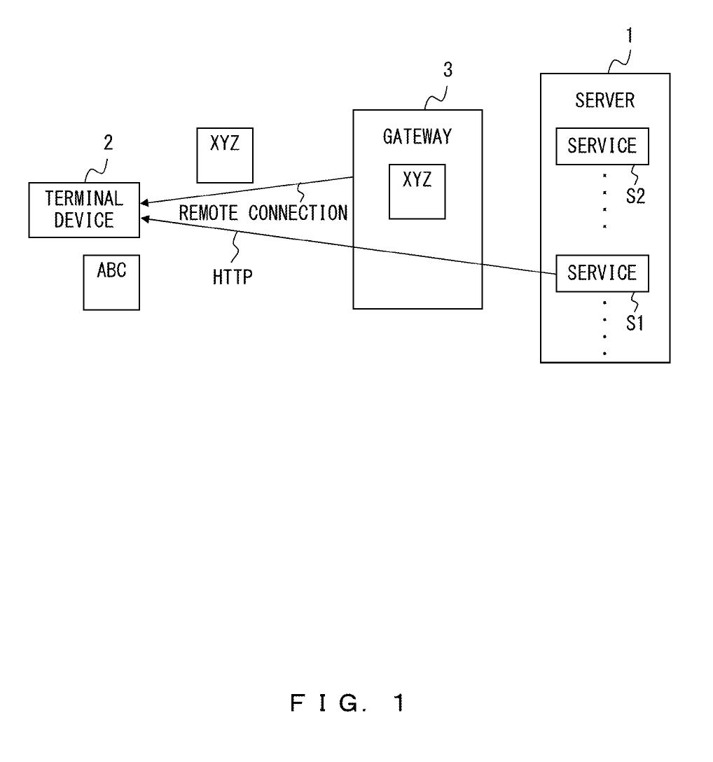

FIG. 1 illustrates a configuration of a Web system according to an embodiment of the present invention. As an example, a server 1 is a Web server computer operated by an enterprise. In this case, a terminal device 2 is a communication device used by an employee of the enterprise. The communication device is a wireless communication device, such as a smartphone and a tablet. A gateway 3 is provided between the terminal device 2 and the server 1 to relay communication between the terminal device 2 and the server 1. The server 1 and the gateway 3 are operated by the same enterprise in this example.

The server 1 can provide various services. Each service is provided by execution of one or a plurality of applications. The terminal device 2 can use the services provided by the server 1. In this case, the terminal device 2 accesses the server 1 through the gateway 3. The terminal device 2 and the gateway 3 are connected through the use of, for example, a VPN (Virtual Private Network) to ensure the security.

The capacity of the line between the gateway 3 and the server 1 is sufficiently greater than that of the line between the terminal device 2 and the gateway 3. That is, when data is transmitted from the server 1 to the terminal device 2 through the gateway 3, the data transmission time from the server 1 to the gateway 3 is significantly shorter than the data transmission time from the gateway 3 to the terminal device 2.

The terminal device 2 may execute an application corresponding to a service, for example. In this case, the communication protocol between the server 1 and the terminal device 2 is HTTP, for example. In the example illustrated in FIG. 1, the terminal device 2 executes an application corresponding to a service S1. As a result, the terminal device 2 generates an image “ABC . . . ”. In this specification, “execution of application” includes a process of generating an image displayed on a display device.

However, if the performance of the terminal device 2 is low for example, the time required for the display of a screen corresponding to the service increases when the terminal device 2 executes the application. More specifically, the response of service is deteriorated in the terminal device 2.

Therefore, the gateway 3 of the Web system according to the embodiment may execute an application of a service requested from the terminal device 2 to generate an image corresponding to the service. In the example illustrated in FIG. 1, the gateway 3 executes an application corresponding to a service S2. As a result, the gateway 3 generates an image “XYZ . . . ”. The gateway 3 transmits the generated image to the terminal device 2 by remote connection scheme, and the terminal device 2 receives the image by the remote connection scheme to display the image on the display device. Although not particularly limited, the remote connection scheme includes a procedure, in which, for example, a terminal device connects to other communication equipment (gateway 3 here) through the network, the communication equipment executes an application or the like to generate image data, and the terminal device receives the image data to display the image data on a display device. In this way, the remote connection scheme is performed according to the situation in the Web system of the embodiment. The remote connection scheme improves the response of service in the terminal device 2.

However, when a large number of terminal devices exist under the gateway 3 and the remote connection is executed for all terminal devices, the process of the gateway 3 may slow down. In this case, the user of the terminal device 2 may reload the same link by deciding that the Web browser is terminated or may request connection to another link, for example. Therefore, the gateway 3 of the embodiment can determine whether to execute the remote connection to improve the response of service in the terminal device 2.

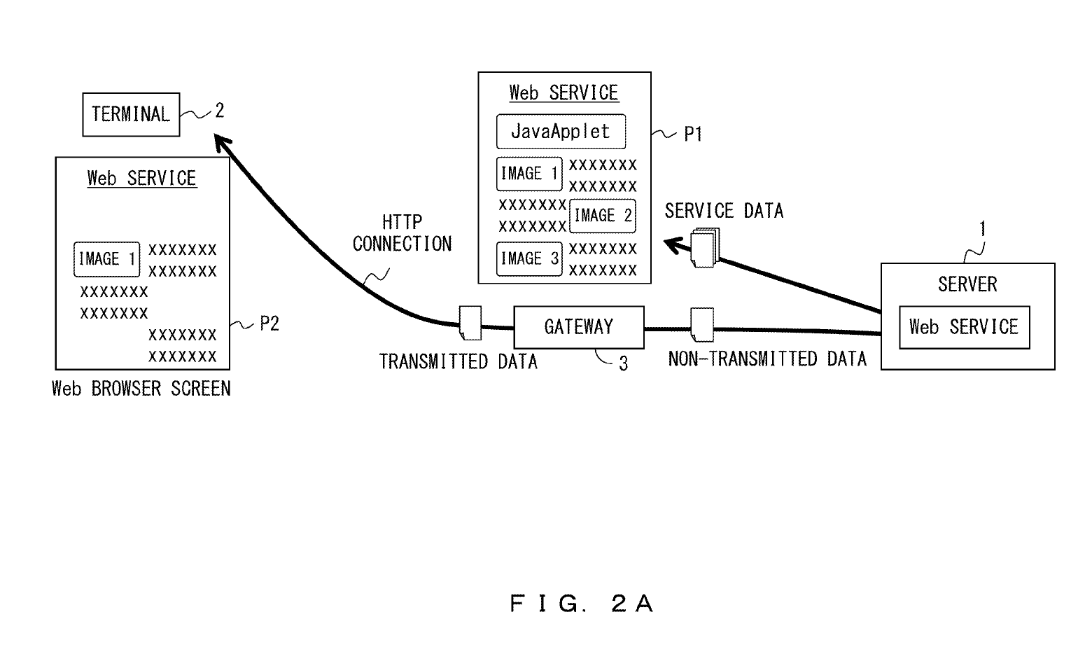

FIGS. 2A and 2B illustrate an outline of a communication control method according to the embodiment of the present invention. In this case, a Web service is requested from the terminal device 2 to the server 1, and service data is transmitted from the server 1 to the terminal device 2. The service data includes data and/or programs related to an application for implementing the service. The request transmitted from the terminal device 2 is transferred to the server 1 through the gateway 3. The service data transmitted from the server 1 is transferred to the terminal device 2 through the gateway 3. In this case, the terminal device 2 and the server 1 are connected based on HTTP, for example.

The gateway 3 requests the server 1 for the same service as the service requested by the terminal device 2. As a result, the server 1 also transmits, to the gateway 3, the same data as the service data transmitted to the terminal device 2 as illustrated in FIG. 2A. The capacity of the line between the gateway 3 and the server 1 is sufficiently greater than that of the line between the terminal device 2 and the gateway 3. Therefore, the gateway 3 completes the reception of the service data requested by the gateway 3 before the completion of the transmission of the service data from the server 1 to the terminal device 2.

The gateway 3 generates an image corresponding to the service based on the service data received from the server 1. In FIG. 2A, the gateway 3 generates an image P1. The image P1 is substantially the same as an image (complete image) ultimately displayed in the terminal device 2. The image P1 includes “Java Applet”, “Image 1”, “Image 2”, and “Image 3”.

In a relay process of the service data transmitted from the server 1 to the terminal device 2, the gateway 3 detects data already transmitted from the gateway 3 to the terminal device 2 (hereinafter, “transmitted data”) and data not yet transmitted from the gateway 3 to the terminal device 2 (hereinafter, “non-transmitted data”). Then the gateway 3 calculates or estimates time required to transmit the non-transmitted data to the terminal device 2 (hereinafter, “non-transmitted data transmission time”).

The terminal device 2 generates and displays a corresponding image based on the received service data. The terminal device 2 can generate and display an image corresponding to part of the service data when the part of the service data is received. In the example illustrated in FIG. 2A, the terminal device 2 generates and displays an image P2 based on part of the service data. The image P2 includes the “Image 1”.

The gateway 3 reproduces the image P2 displayed on the terminal device 2 based on the transmitted data. The gateway 3 compares the image P1 and the image P2 to detect a region where corresponding image is not displayed in the terminal device 2 (hereinafter, “non-displayed region”). In this case, the gateway 3 may generate a difference image between the image P1 and the image P2. In the example illustrated in FIG. 2B, three shaded regions represent the non-displayed regions. As a result, the gateway 3 can determine that the “Java Applet”, the “Image 2”, and the “Image 3” are not displayed in the terminal device 2.

The gateway 3 calculates or estimates time (hereinafter, “non-displayed image transmission time”) required to transmit, to the terminal device 2, an image (hereinafter, “non-displayed region image”) to be displayed on the non-displayed region in the terminal device 2. In the example illustrated in FIG. 2B, the time required for transmitting the “Java Applet”, the “Image 2”, and the “Image 3” from the gateway 3 to the terminal device 2 is calculated. Then the gateway 3 compares the non-transmitted data transmission time and the non-displayed image transmission time.

If the non-transmitted data transmission time is equal to or shorter than the non-displayed image transmission time, the gateway 3 transmits the non-transmitted data to the terminal device 2. In this case, the communication based on the HTTP continues. The terminal device 2 also generates images from the received data.

On the other hand, if the non-displayed image transmission time is shorter than the non-transmitted data transmission time, the gateway 3 transmits the non-displayed region images to the terminal device 2. In the example illustrated in FIG. 2B, the gateway 3 transmits the non-displayed region images (“Java Applet”, “Image 2”, and “Image 3”) to the terminal device 2. In this case, the communication between the terminal device 2 and the gateway 3 is switched from the HTTP to the remote connection.

The terminal device 2 combines the image P2 generated earlier and the non-displayed region images received from the gateway 3 to generate an image P3. At this point, the terminal device 2 may copy the image P2 to a remote connection screen and arrange the non-displayed region images on the screen, for example. In this case, the browser screen is seamlessly switched to the remote connection screen.

In this way, the image generated by the gateway 3 is transmitted to the terminal device 2 when the non-displayed image transmission time is shorter than the non-transmitted data transmission time in the communication control method of the embodiment. The terminal device 2 does not have to execute the application to generate the image when the image generated by the gateway 3 is received. This improves the response of service in the terminal device 2. The remote connection is not executed for all terminal devices under the gateway 3. Therefore, the resources of the gateway 3 are efficiently used.

In the example illustrated in FIGS. 2A and 2B, the gateway 3 determines the scheme of connection between the gateway 3 and the terminal device 2 based on the non-transmitted data transmission time and the non-displayed image transmission time. However, this method is an example, and the gateway 3 may take other factors into account to determine the scheme of connection between the gateway 3 and the terminal device 2. More specifically, the gateway 3 may determine the scheme of connection between the gateway 3 and the terminal device 2 based on a cost in the scheme of transmitting the non-transmitted data from the gateway 3 to the terminal device 2 and a cost in the scheme of transmitting the non-displayed region images from the gateway 3 to the terminal device 2. In this case, the non-transmitted data transmission time and the non-displayed image transmission time are factors of the costs. The resources of the terminal device 2 (such as performance of CPU and capacity of memory) may also be used as factors of the costs. When a communication bandwidth in the transfer of the non-transmitted data and a communication bandwidth in the transfer of the non-displayed region image data are different for example, the communication bandwidth may be used as factors of the costs.

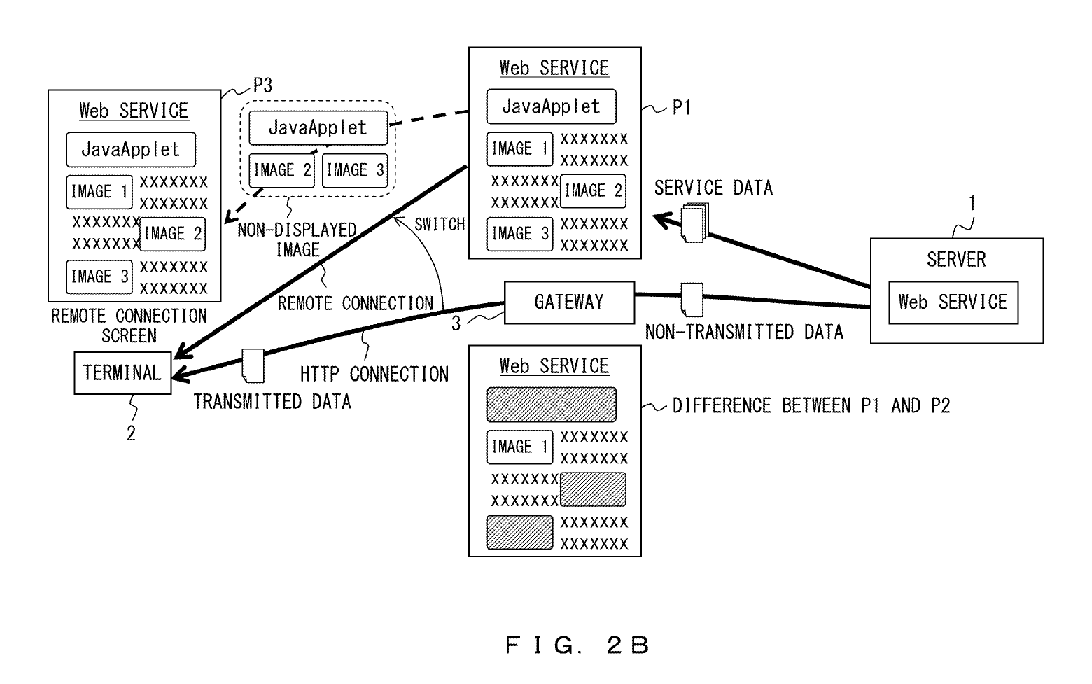

FIG. 3 illustrates hardware configurations of the terminal device 2, the server 1, and the gateway 3.

The terminal device 2 includes a CPU 21, a ROM (Read Only Memory) 22, a RAM (Random Access Memory) 23, an HDD (Hard Disk Drive) 24, a NIC (Network Interface Card) 25, and an input-output device 26. The CPU 21, the ROM 22, the RAM 23, the HDD 24, the NIC 25, and the input-output device 26 are connected to each other through a bus, for example.

The CPU 21 controls the operation of the terminal device 2. The CPU 21 may include a plurality of processor elements. The ROM 22 stores programs such as a boot program. The ROM 22 may also store programs related to the communication control method of the embodiment. The RAM 23 is used as a work area of the CPU 21. The HDD 24 stores data and/or programs used by the CPU 21. The programs related to the communication control method of the embodiment may be stored in the HDD 24. In this case, the CPU 21 may read the programs from the HDD 24 and load the programs on the RAM 23 to execute the programs. The terminal device 2 may include another storage device (for example, SSD (Solid State Drive)) in place of the HDD 24.

The NIC 25 provides an interface for connection to the network. Examples of the network include a LAN (Local Area Network), a WAN (Wide Area Network), and the Internet. The NIC 25 provides an interface for connection to the gateway 3 through the network. The input-output device 26 includes an input device, such as a keyboard and/or a mouse. The input-output device 26 also includes an output device, such as a display, a camera, and/or a sensor device.

The gateway 3 includes a CPU 31, a ROM 32, a RAM 33, an HDD 34, and NICs 35. The CPU 31, the ROM 32, the RAM 33, the HDD 34, and the NICs 35 are substantially the same as the CPU 21, the ROM 22, the RAM 23, the HDD 24, and the NIC 25, and the description will not be repeated. Although the gateway 3 includes two NICs 35 in the example illustrated in FIG. 3, the number of NICs included in the gateway 3 is not limited.

The server 1 includes a CPU 11, a ROM 12, a RAM 13, an HDD 14, and a NIC 15. The CPU 11, the ROM 12, the RAM 13, the HDD 14, and the NIC 15 are substantially the same as the CPU 21, the ROM 22, the RAM 23, the HDD 24, and the NIC 25, and the description will not be repeated.

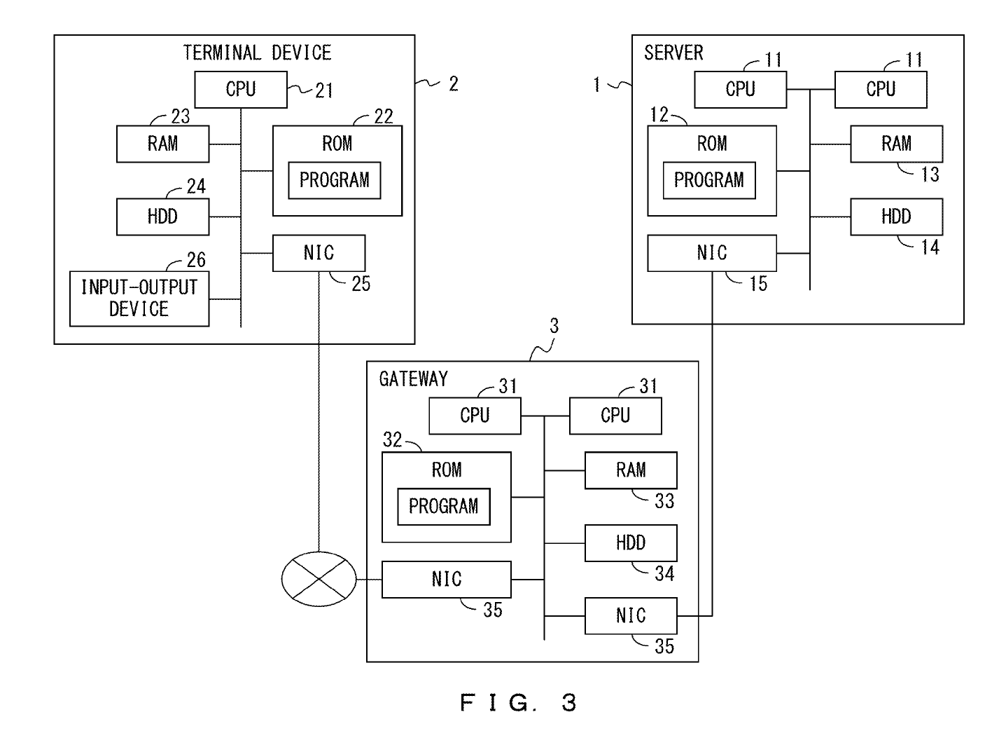

FIG. 4 is a diagram illustrating functions of the terminal device 2, the gateway 3, and the server 1. The terminal device 2 includes a Web browser 41, a control information transmitter 42, a remote connection client 43, a remote connection screen configuration unit 44, and a screen selector 45. The terminal device 2 may have other functions.

The Web browser 41 accesses the server 1 to acquire service data corresponding to a desired Web service. In this case, the Web browser 41 can access the URL designated by the user. The Web browser 41 executes an application program included in the service data acquired from the accessed URL. The control information transmitter 42 transmits control information to the gateway 3. The control information includes information related to the resources of the terminal device 2, the URL of the Web service, data for measuring the communication bandwidth between the terminal device 2 and the gateway 3, etc.

The remote connection client 43 accesses a remote connection server 55 of the gateway 3 to execute remote connection. The remote connection screen configuration unit 44 forms a remote connection screen based on an image of a Web browser screen generated by the Web browser 41 and image data received from the gateway 3 through the remote connection scheme. The screen selector 45 selects and displays one of the Web browser screen generated by the Web browser 41 and the remote connection screen formed by the remote connection screen configuration unit 44.

The CPU 21 executes software programs to realize the Web browser 41, the control information transmitter 42, the remote connection client 43, the remote connection screen configuration unit 44, and the screen selector 45. However, hardware circuits may realize part of the Web browser 41, the control information transmitter 42, the remote connection client 43, the remote connection screen configuration unit 44, and the screen selector 45.

The gateway 3 includes a relay 51, a transmitted data storage 52, a control information receiver 53, a Web browser 54, the remote connection server 55, an execution decision unit 56, an execution decision information storage 57, a non-displayed region detector 58, a transmission scheme decision unit 59, and a data transmitter 60. The gateway 3 may have other functions.

The relay 51 relays data transferred between the server 1 and the terminal device 2. The server 1 and the terminal device 2 are connected based on the HTTP, for example. The relay 51 can extract data transmitted from the server 1 to the terminal device 2. The transmitted data storage 52 stores data transmitted from the server 1 to the terminal device 2. In this case, data information indicating the data name, the data size, and the like of the data transmitted from the gateway 3 to the terminal device 2 is also stored in the transmitted data storage 52. The control information receiver 53 receives control information transmitted from the control information transmitter 42 of the terminal device 2.

The Web browser 54 accesses the server 1 to acquire service data corresponding to the Web service. In this case, the Web browser 54 can execute substantially the same process as the Web browser 41 of the terminal device 2. For example, the Web browser 54 can receive the same data as the service data transmitted to the terminal device 2 based on the request from the terminal device 2. The Web browser 54 can generate an image to be displayed in the terminal device 2 based on the service data received from the server 1. The remote connection server 55 transmits the image data generated by the Web browser 54 to the terminal device 2 based on the remote connection scheme.

The execution decision unit 56 determines which one of the terminal device 2 and the gateway 3 will execute the process of the Web service. The execution decision information storage 57 stores information used for the decision by the execution decision unit 56.

The non-displayed region detector 58 detects an image region not yet displayed in the terminal device 2 from the image corresponding to the service data transmitted from the server 1 to the terminal device 2. The transmission scheme decision unit 59 decides whether to transmit the image data corresponding to the Web service to the terminal device 2 based on the remote connection scheme. The data transmitter 60 transmits the image data of the region detected by the non-displayed region detector 58 to the terminal device 2.

The CPU 31 executes software programs to realize the relay 51, the control information receiver 53, the Web browser 54, the remote connection server 55, the execution decision unit 56, the non-displayed region detector 58, the transmission scheme decision unit 59, and the data transmitter 60. However, hardware circuits may realize part of the relay 51, the control information receiver 53, the Web browser 54, the remote connection server 55, the execution decision unit 56, the non-displayed region detector 58, the transmission scheme decision unit 59, and the data transmitter 60.

The server 1 includes a Web server 71 and a storage 72. The Web server 71 provides Web services requested from the Web browsers 41 and 54. The storage 72 stores data and programs for realizing the Web services.

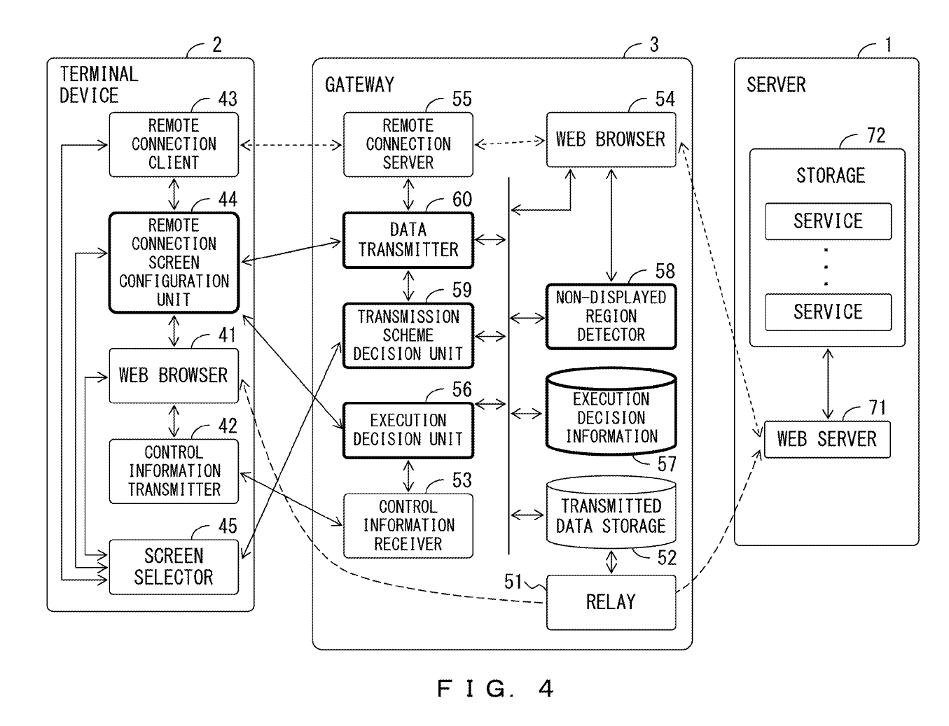

FIG. 5 is a flow chart illustrating the communication control method according to the embodiment of the present invention. The process of the flow chart is executed when the user provides an instruction for requesting a Web service to the terminal device 2, for example.

S1: The Web browser 41 of the terminal device 2 accesses the server 1 through the gateway 3. In this case, the Web browser 41 accesses the URL corresponding to the Web service designated by the user. By so doing, the service data corresponding to the designated Web service is transmitted from the server 1 to the terminal device 2. The relay 51 of the gateway 3 relays the service data.

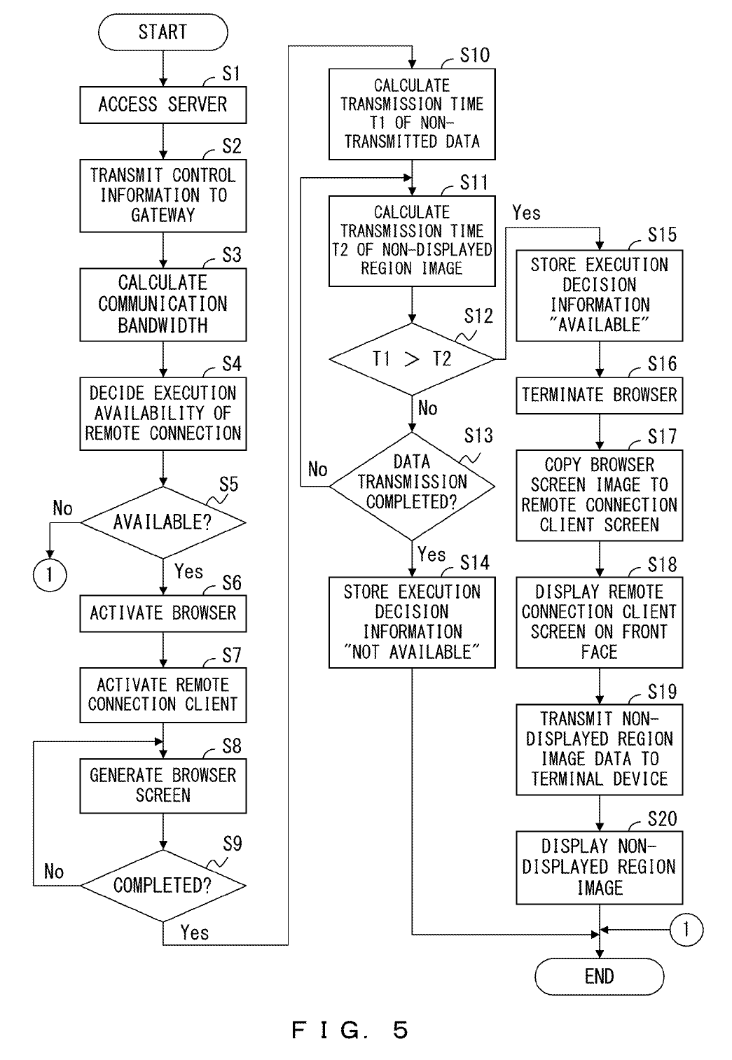

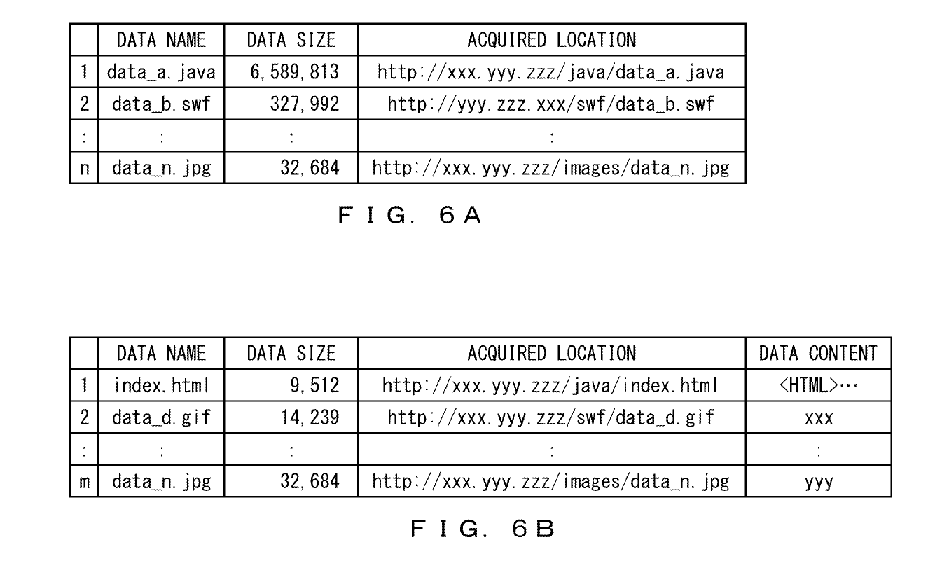

In this case, the relay 51 detects the data name, the data size, and the data content of the data element transmitted to the terminal device 2. The relay 51 stores the detected data name, data size, and data content in the transmitted data storage 52 as transmitted data. FIG. 6B illustrates an example of the transmitted data stored in the transmitted data storage 52. Data elements index.html, data d.gif, . . . , and data_n.jpg are recorded in this example. In addition to the data name, the data size, and the data content, information indicating the acquired location is also recorded in this example.

A certain time is required to transmit all service data from the server 1 to the terminal device 2. Therefore, S2 to S20 are executed in parallel with the transmission of the service data from the server 1 to the terminal device 2.

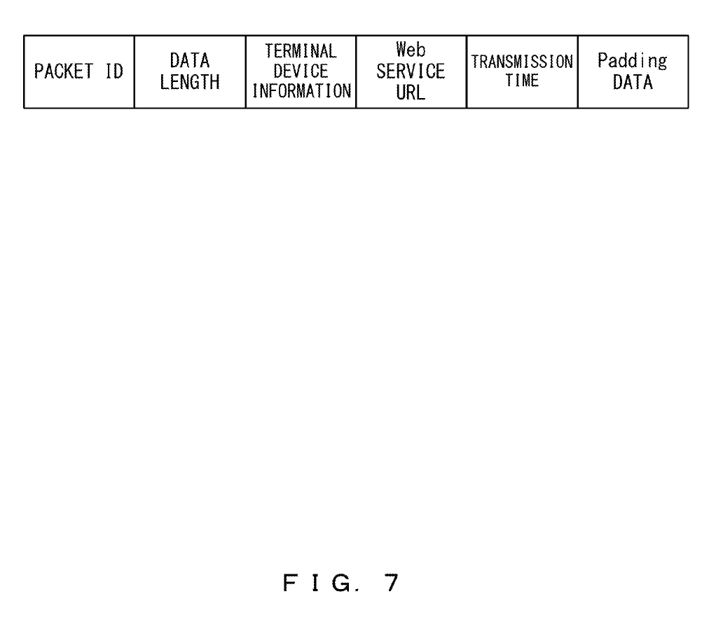

S2: In the terminal device 2, the control information transmitter 42 transmits control information to the gateway 3 when access to the server 1 by the Web browser 41 is detected. FIG. 7 illustrates an example of the control information.

In this example, the control information is stored in a packet and transmitted from the terminal device 2 to the gateway 3. A packet ID identifies the packet storing the control information. A data length denotes the data length of the packet. Terminal device information denotes the performance of the CPU of the terminal device 2, the capacity of the memory of the terminal device 2, etc. A Web service URL denotes the URL accessed from the terminal device 2 to the server 1. Transmission time denotes the time of the transmission of the packet from the terminal device 2.

S3: In the gateway 3, the control information receiver 53 receives the control information generated by the terminal device 2. The control information receiver 53 calculates the communication bandwidth between the terminal device 2 and the gateway 3 based on the received control information. In the calculation of the communication bandwidth, the control information receiver 53 detects the time of the reception of the control information. The time of the terminal device 2 and the time of the gateway 3 are synchronized based on NTP, for example. Therefore, the control information receiver 53 can calculate the communication bandwidth between the terminal device 2 and the gateway 3 based on the following formula.

Communication bandwidth [bps]=data length [bit]/packet transmission time [sec]

Packet transmission time=reception time−transmission time Then the control information receiver 53 notifies the execution decision unit 56 of the received control information and the calculated communication bandwidth.

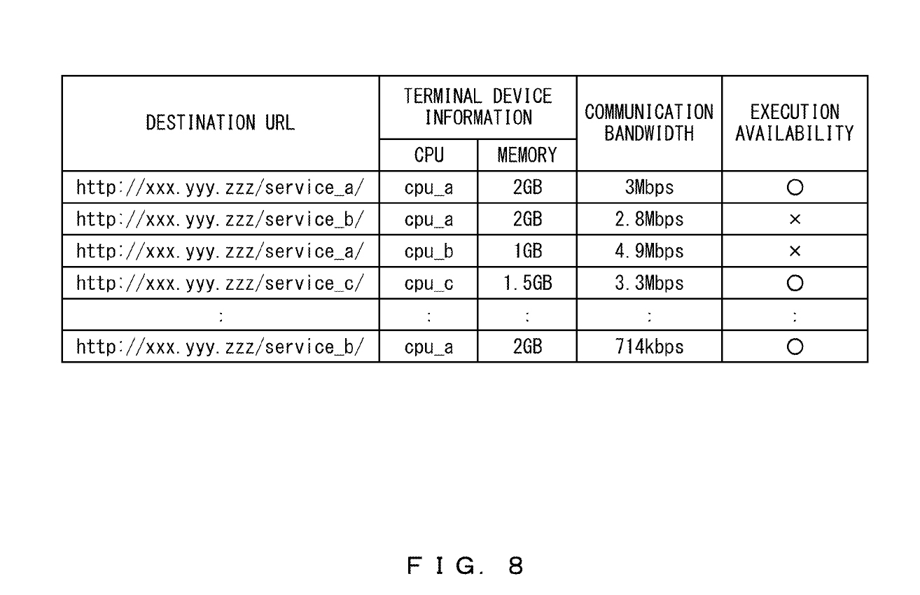

S4 and S5: In the gateway 3, the execution decision unit 56 determines whether image data transmission through the remote connection can be executed based on the control information received from the terminal device 2 and the communication bandwidth calculated in S3. In this case, the execution decision unit 56 refers to execution decision information stored in the execution decision information storage 57. FIG. 8 illustrates an example of the execution decision information.

In the example illustrated in FIG. 8, the execution decision information indicates whether the image data transmission based on the remote connection can be executed for combinations of “Destination URL”, “Terminal Device Information”, and “Communication Bandwidth”. The destination information denotes the URL of the Web service requested from the terminal device 2. The terminal device information denotes the performance of the CPU of the terminal device 2 and the capacity of the memory of the terminal device 2. The communication bandwidth denotes the communication bandwidth between the terminal device 2 and the gateway 3. A symbol “O” denotes that the image data transmission based on the remote connection can be executed, and a symbol “X” denotes that the image data transmission based on the remote connection cannot be executed.

The execution decision information indicates past decision results. For example, a first record illustrated in FIG. 8 indicates the following results.
(1) The terminal device includes a CPU_a and a memory of 2 GB.
(2) The communication bandwidth between the terminal device and the gateway 3 is 3 Mbps.
(3) The URL of a service a is accessed.
(4) In this case, the image data transmission based on the remote connection is executed.

A second record illustrated in FIG. 8 indicates the following decision results.
(1) The terminal device includes a CPU_a and a memory of 2 GB.
(2) The communication bandwidth between the terminal device and the gateway 3 is 2.8 Mbps.
(3) The URL of a service b is accessed.
(4) In this case, the image data transmission based on the remote connection is not executed.

Therefore, the execution decision unit 56 can decide whether the image data transmission based on the remote connection can be executed by referring to the execution decision information in the “Destination URL”, the “Terminal Device Information”, and the “Communication Bandwidth” in relation to new access from the terminal device to the server 1. For example, when the terminal device that newly accesses the server 1 includes a CPU_a and a memory of 2 GB, the communication bandwidth is 3 Mbps, and the destination is a service a, it is determined that the image data transmission is “Available” according to the execution decision information illustrated in FIG. 8.

If it is determined that the image data transmission based on the remote connection can be executed, the process of the communication control method proceeds to S6. On the other hand, if it is determined that the image data transmission based on the remote connection cannot be executed, the process of the communication control method ends. In this case, the image data transmission based on the remote connection is not executed, and the terminal device 2 receives the service data from the server 1 based on the HTTP.

S6: In the gateway 3, the execution decision unit 56 activates the Web browser 54. In this case, the execution decision unit 56 notifies the Web browser 54 of the “Destination URL” in the control information received from the terminal device 2. The Web browser 54 accesses the notified URL. More specifically, the gateway 3 accesses the same Web service as the Web service accessed by the terminal device 2 in S1. The execution decision unit 56 further notifies the terminal device 2 of the decision result (decision result: available) indicating that the image data transmission based on the remote connection can be executed. The remote connection screen configuration unit 44 receives the decision result.

S7: In the terminal device 2, the remote connection screen configuration unit 44 activates the remote connection client 43. Consequently, the remote connection client 43 connects to the remote connection server 55. However, the image data is not transmitted from the remote connection server 55 to the remote connection client 43 at this point.

S8 and S9: In the gateway 3, the Web browser 54 acquires the service data from the server 1 (i.e. URL accessed in S6). The Web browser 54 stores the data information (data name, data size, and acquired location) of the received service data in a specified memory region. In this case, the Web browser 54 analyzes the received service data to acquire the service information. Alternatively, the Web browser 54 may receive the data information of the service data from the server 1 along with the service data. The memory region for storing the service information is not particularly limited. The memory region may be a file, a database, or a storage device such as an HDD. FIG. 6A illustrates an example of the data information of the received service data. In this example, the service data corresponding to the Web service includes n data elements. The data name, the data size, and the destination are recorded for each data element.

The Web browser 54 executes the service data received from the server 1 to generate an image of the browser screen. The generated image is equivalent to the screen image displayed by the Web browser 41 in the terminal device 2. When the reading of the service data of the Web service is completed (i.e. when the generation of the image of the Web service is completed), the Web browser 54 transmits a completion notification to the non-displayed region detector 58 and the transmission scheme decision unit 59.

S10: When the completion notification is received from the Web browser 54, the transmission scheme decision unit 59 detects non-transmitted data that is not yet transmitted to the terminal device 2 in the service data transmitted from the server 1 to the terminal device 2. The Web browser 54 detects the service data transmitted from the server 1 to the terminal device 2 as illustrated in FIG. 6A. The transmitted data that is already transmitted to the terminal device 2 is stored in the transmitted data storage 52 as illustrated in FIG. 6B. Therefore, the non-transmitted data is detected by referring to the information. In the example illustrated in FIGS. 6A and 6B, at least data_a and data b are not yet transmitted from the gateway 3 to the terminal device 2. When the data_a and the data_b are non-transmitted data, the total data size is 6917805 bytes.

The transmission scheme decision unit 59 calculates or estimates time T1 required for transmitting the non-transmitted data to the terminal device 2 based on the following formula. The communication bandwidth is calculated in S3.

Transmission time T1=data size of non-transmitted data/communication bandwidth

S11: When the completion notification is received from the Web browser 54, the non-displayed region detector activates the Web browser 54 to generate an image (hereinafter, may be called “current screen”) corresponding to the current display state in the terminal device 2. As illustrated in FIG. 6B, the service data already received by the terminal device 2 is stored as transmitted data in the transmitted data storage 52. Therefore, the non-displayed region detector 58 can generate the image (i.e. current screen) corresponding to the current display state in the terminal device 2 by referring to the transmitted data storage 52.

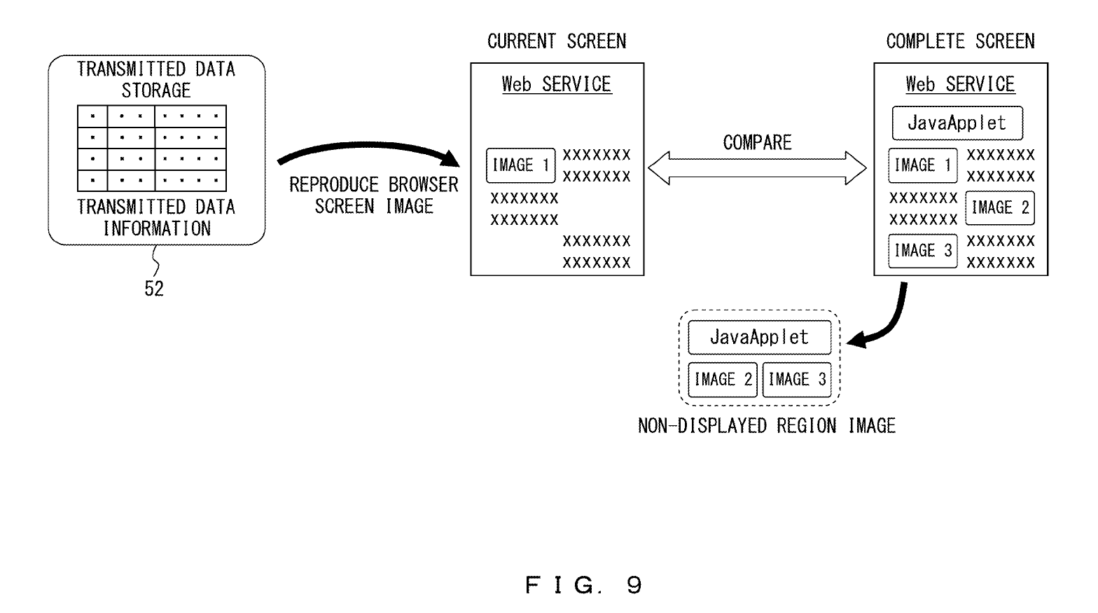

Then, the non-displayed region detector 58 detects an image region that is not yet displayed in the terminal device 2 in the image corresponding to the Web service provided from the server 1 to the terminal device 2. In this case, the non-displayed region detector 58 compares the image generated in S8 (complete screen in FIG. 9) and the image corresponding to the current display state in the terminal device 2 (current screen in FIG. 9) to detect an image of the non-displayed region.

An example will be illustrated with reference to FIG. 9. In this example, the current screen corresponding to the current display state in the terminal device 2 includes the “Image 1”. The non-displayed region detector 58 can generate the current screen by referring to the transmitted data storage 52. The non-displayed region detector 58 generates the complete screen based on the service data of the Web service acquired by the gateway 3 from the server 1. The complete screen is equivalent to a screen displaying all service data for providing the requested Web service. In this example, the complete screen includes the “Java Applet”, the “Image 1”, the “Image 2”, and the “Image 3”.

The non-displayed region detector 58 compares the current screen and the complete screen to detect the image of the region that is not yet displayed in the terminal device 2 (i.e. non-displayed region image). In this example, it is estimated that the “Image 1” among the “Java Applet”, the “Image 1”, the “Image 2”, and the “Image 3” is already displayed on the terminal device 2. Therefore, it is determined that the “Java Applet”, the “Image 2”, and the “Image 3” are the non-displayed region images.

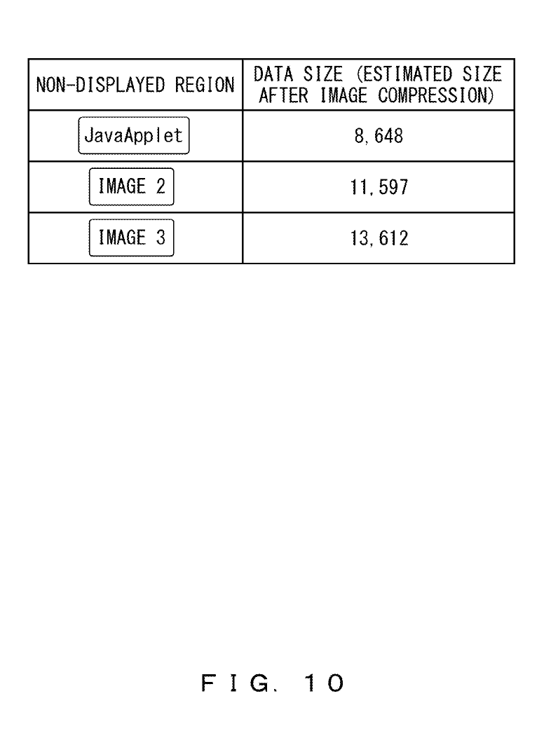

Subsequently, the non-displayed region detector 58 calculates or estimates time required for transmitting the non-displayed region images from the gateway 3 to the terminal device 2. The non-displayed region detector 58 calculates the data size of each image element of the non-displayed region images. When the image data is compressed and transmitted from the gateway 3 to the terminal device 2, the data size of the compressed image data is calculated. In this example, the data size of each image element (Java Applet, Image 2, and Image 3) of the non-displayed region images is calculated as illustrated in FIG. 10. As a result, the total data size of the non-displayed region images is 33857 bytes. The non-displayed region detector 58 calculates transmission time T2 required for transmitting the non-displayed region image data from the gateway 3 to the terminal device 2 based on the following formula. The communication bandwidth is calculated by the control information receiver 53 in S3.

Transmission time T2=data size of non-displayed region image/communication bandwidth

S12: The transmission scheme decision unit 59 compares the transmission time T1 of the non-transmitted data and the transmission time T2 of the non-displayed region image. If the transmission time T2 of the non-displayed region image is equal to or longer than the transmission time T1 of the non-transmitted data, the process of the transmission scheme decision unit 59 proceeds to S13. On the other hand, if the transmission time T2 of the non-displayed region image is shorter than the transmission time T1 of the non-transmitted data, the transmission scheme decision unit 59 transmits a request termination instruction to the screen selector 45 of the terminal device 2 and provides a transmission request to the data transmitter 60. The process of the transmission scheme decision unit 59 then proceeds to S15.

S13: The transmission scheme decision unit 59 determines whether all service data of the Web service requested by the terminal device 2 is transmitted to the terminal device 2. If non-transmitted data remains, the process of the gateway 3 returns to S10. More specifically, S10 to S13 are repeated until “T1>T2” is detected or until all service data is transmitted to the terminal device 2.

S14: If all service data is transmitted from the gateway 3 to the terminal device 2 without the detection of “T1>T2”, the transmission scheme decision unit 59 stores, in the execution decision information storage 57, information indicating that the image data transmission based on the remote connection is not executed. In this case, “Execution Availability: Not Available” is recorded for the combination of the destination URL, the terminal device information of the terminal device 2, and the communication bandwidth between the terminal device 2 and the gateway 3 as illustrated in FIG. 8.

S15: If “T1>T2” is detected, the transmission scheme decision unit 59 transmits a request termination instruction to the terminal device 2. In addition, the transmission scheme decision unit 59 stores, in the execution decision information storage 57, information indicating that the image data transmission based on the remote connection is executed. In this case, “Execution Availability: Available” is recorded for the combination of the destination URL, the terminal device information of the terminal device 2, and the communication bandwidth between the terminal device 2 and the gateway 3 as illustrated in FIG. 8. If the execution availability information is already recorded for the combination of the destination URL, the terminal device information of the terminal device 2, and the communication bandwidth, the process of storing the determination result in the execution decision information storage 57 may be skipped.

The execution availability information recorded in S14 or S15 is used when a new service request is issued from the terminal device. More specifically, the gateway 3 refers to the result of the execution availability decision for the same service request in the past based on the destination URL, the terminal device information, and the communication bandwidth of the new service request. For example, if the determination result for the same service request in the past is “Not Available”, it is expected to determine “not to execute the image data transmission based on the remote connection” in S12 when S6 to S12 are executed for the new service request. Therefore, the gateway 3 does not start the process for the remote connection in this case. As a result, unnecessary execution of the process is prevented, and the efficiency of the gateway 3 improves.

S16: In the terminal device 2, the screen selector 45 receives the request termination instruction from the transmission scheme decision unit 59. Consequently, the screen selector 45 instructs the Web browser 41 to terminate the data acquisition. The Web browser 41 terminates the process of acquiring the service data from the server 1 and notifies the remote connection screen configuration unit 44 of the completion of the termination of the data acquisition. When the Web browser 41 terminates the process of acquiring the service data, the relay 51 in the gateway 3 terminates the process of transmitting the service data.

S17: In the terminal device 2, the remote connection screen configuration unit 44 copies the image of the browser screen generated by the Web browser 41 to the display screen of the remote connection client 43. The remote connection screen configuration unit 44 transmits a copy completion notification to the screen selector 45.

S18: In the terminal device 2, the screen selector 45 receives the copy completion notification from the remote connection screen configuration unit 44. By so doing, the screen selector 45 displays the image of the remote connection screen on the front face of the display device of the terminal device 2. Then the screen selector 45 terminates the Web browser 41.

S19: In the gateway 3, the data transmitter 60 uses the non-displayed region detector 58 to acquire the non-displayed region image. The data transmitter 60 converts the acquired non-displayed region image into data of the remote connection scheme and transmits the data to the terminal device 2.

S20: In the terminal device 2, the remote connection screen configuration unit 44 receives the non-displayed region image data from the gateway 3. Then, the remote connection screen configuration unit 44 displays the non-displayed region image received from the gateway 3 on the remote connection screen.

The data transmitter 60 then provides a transmission request to the remote connection server 55. When the transmission request is received, the remote connection server 55 transmits the image data generated by the Web browser 54 to the terminal device 2 based on the remote connection scheme hereafter. The remote connection client 43 of the terminal device 2 receives the image data.

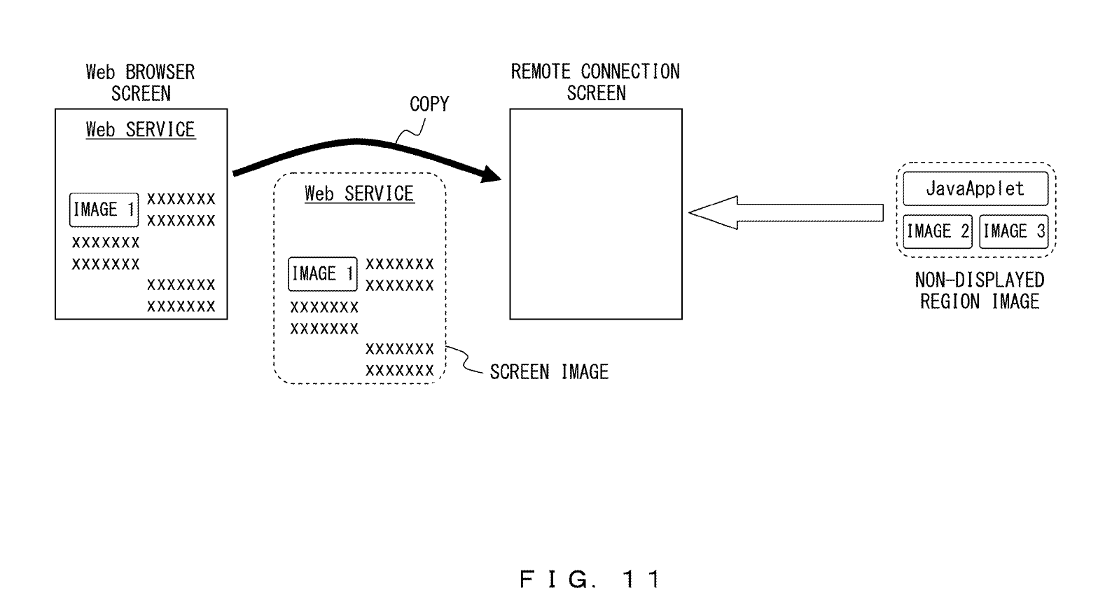

The example of S17 to S20 will be described with reference to FIG. 11. In S17, the remote connection screen configuration unit 44 copies the image of the Web browser screen to the remote connection screen. In FIG. 11, an image including the “Image 1” is copied to the remote connection screen. In S19, the data transmitter 60 transmits the non-displayed region image data to the terminal device 2. In FIG. 11, image data including the “Java Applet”, the “Image 2”, and the “Image 3” is transmitted from the gateway 3 to the terminal device 2.

In S20, the remote connection screen configuration unit 44 displays the non-displayed region image on the remote connection screen. In this case, the image acquired from the Web browser screen is already displayed on the remote connection screen. Therefore, on the remote connection screen, the remote connection screen configuration unit 44 superimposes the non-displayed region image received from the gateway 3 on the image acquired from the Web browser screen. In FIG. 11, the non-displayed region images (“Java Applet”, “Image 2”, and “Image 3”) are superimposed on the image (“Image 1”) acquired from the Web browser screen.

In this way, the data necessary for realizing the Web service is transmitted to the terminal device 2 based on the scheme with the shorter transmission time from the gateway 3 to the terminal device 2 in the communication control method of the embodiment. Therefore, according to the communication control method of the embodiment, the response of service provided from the server 1 to the terminal device 2 improves.

According to the communication control method of the embodiment, the terminal device 2 combines the image generated by the Web browser and the image received based on the remote connection to generate the display image. Therefore, the Web browser is seamlessly switched to the remote connection.

In the example, whether to switch the HTTP to the remote connection is determined based on the comparison result of the transmission time of the non-transmitted data and the transmission time of the non-displayed region image. However, if the communication bandwidth for transmitting the non-transmitted data and the communication bandwidth for transmitting the non-displayed region image are the same, whether to switch the Web browser to the remote connection may be determined based on the comparison result of the data size of the non-transmitted data and the data size of the non-displayed region image.

Operation of the terminal device 2 and the gateway 3 will be described in detail.

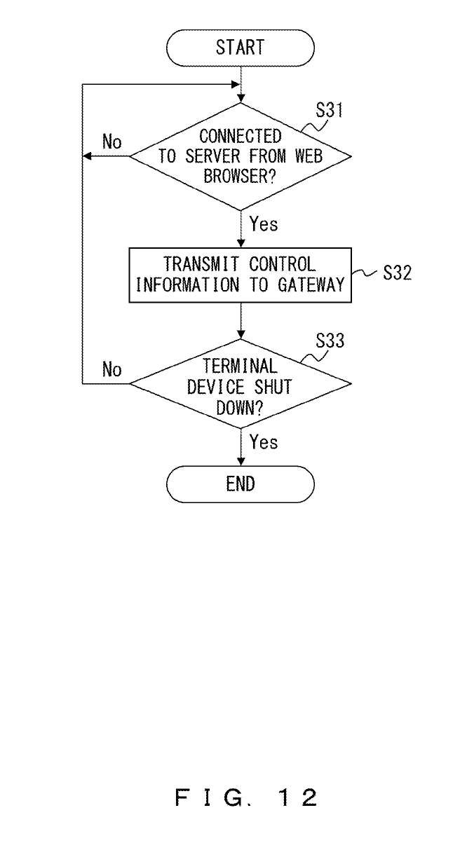

FIG. 12 is a flow chart illustrating a process of the control information transmitter 42. The process of the flow chart corresponds to S2 of FIG. 5.

In S31, the control information transmitter 42 monitors operation of the Web browser 41. When the Web browser 41 requests the server 1 for a Web service, the control information transmitter 42 generates control information and transmits the control information to the gateway 3 in S32. An example of the control information is as described with reference to FIG. 7. In the gateway 3, the control information receiver 53 receives the control information. In S33, the control information transmitter 42 monitors the start of a shutdown procedure of the terminal device 2. More specifically, the control information transmitter 42 repeats the process of S31 and S32 until the shutdown procedure of the terminal device 2 is started.

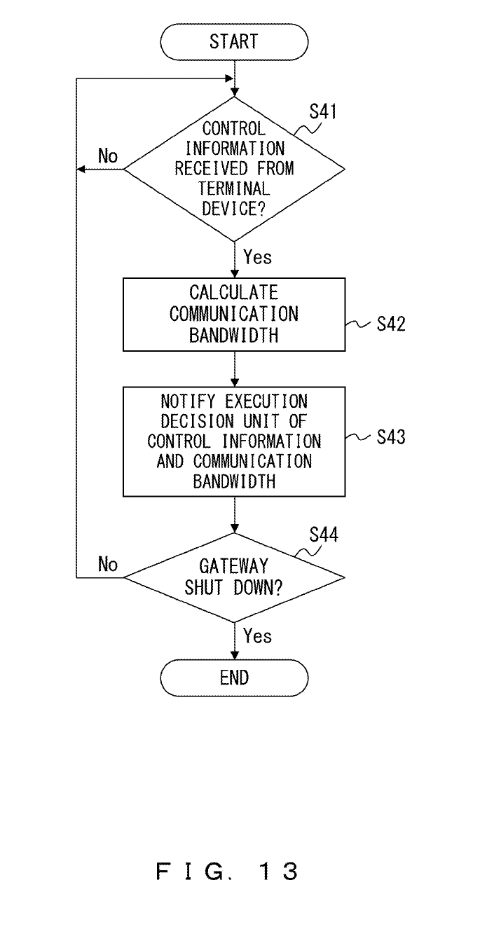

FIG. 13 is a flow chart illustrating a process of the control information receiver 53. The process of the flow chart corresponds to S3 of FIG. 5.

In S41, the control information receiver 53 waits for control information transmitted from the terminal device 2. The control information is transmitted from the control information transmitter 42 of the terminal device 2 as described with reference to FIG. 12. When the control information is received from the terminal device 2, the control information receiver 53 calculates a communication bandwidth between the terminal device 2 and the gateway 3 based on the control information in S42. In this case, the control information receiver 53 calculates the communication bandwidth based on the data length, the transmission time, and the reception time of the packet storing the control information, for example. Alternatively, the control information receiver 53 may calculate the communication bandwidth based on RTT (Round-Trip Time).

In S43, the control information receiver 53 notifies the execution decision unit 56 of the control information received from the terminal device 2 and the calculated communication bandwidth. In S44, the control information receiver 53 monitors the start of a shutdown procedure of the gateway 3. More specifically, the control information receiver 53 repeats the process of S41 to S43 until the shutdown procedure of the gateway 3 is started.

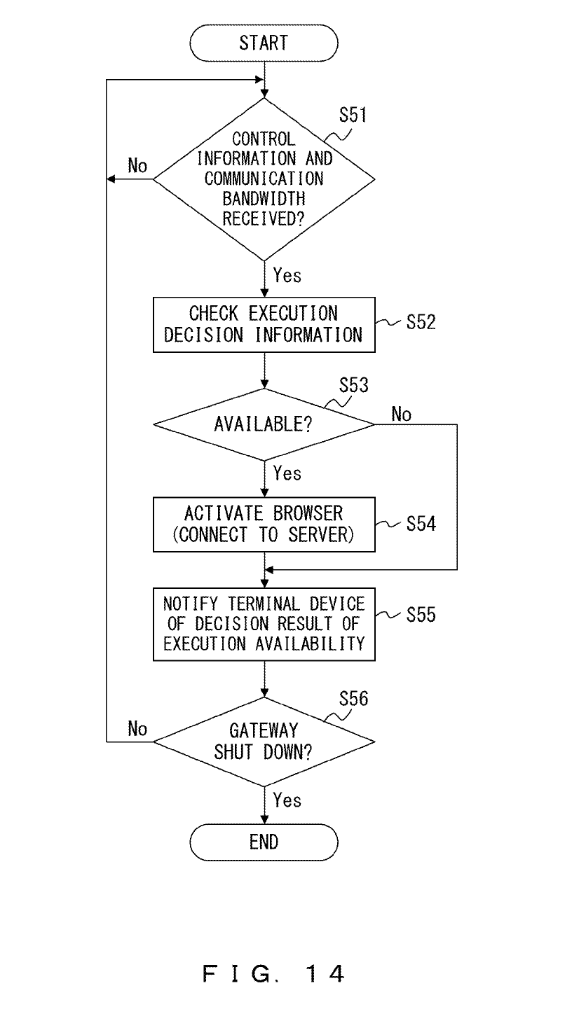

FIG. 14 is a flow chart illustrating a process of the execution decision unit 56. The process of the flowchart corresponds to S4 to S6 of FIG. 5.

In S51, the execution decision unit 56 waits for a notification transmitted from the control information receiver 53 (such as control information (Web service URL, terminal device information, etc.) and communication bandwidth). When the notification from the control information receiver 53 is received, the execution decision unit 56 determines whether the image data transmission based on the remote connection can be executed for the Web service requested by the terminal device 2 in S52 and S53. In this case, the execution decision unit 56 uses the control information and the communication bandwidth as search indexes to refer to the execution decision information stored in the execution decision information storage 57. FIG. 8 illustrates an example of the execution decision information.

When “Execution Availability: Available” is obtained for the control information and the communication bandwidth or when there is no corresponding search index in the execution decision information storage 57, the execution decision unit 56 activates the Web browser 54 in S54. In this case, the execution decision unit 56 provides an access instruction to the Web browser 54 and notifies the Web browser 54 of the “Web Service URL” included in the control information received from the terminal device 2. If “Execution Availability: Not Available” is obtained for the control information and the communication bandwidth, S54 is skipped.

In S55, the execution decision unit 56 notifies the terminal device 2 of the decision result of the execution availability. In the terminal device 2, the remote connection screen configuration unit 44 receives the decision result. In S56, the execution decision unit 56 monitors the start of a shutdown procedure of the gateway 3. More specifically, the execution decision unit 56 repeats the process of S51 to S55 until the shutdown procedure of the gateway 3 is started.

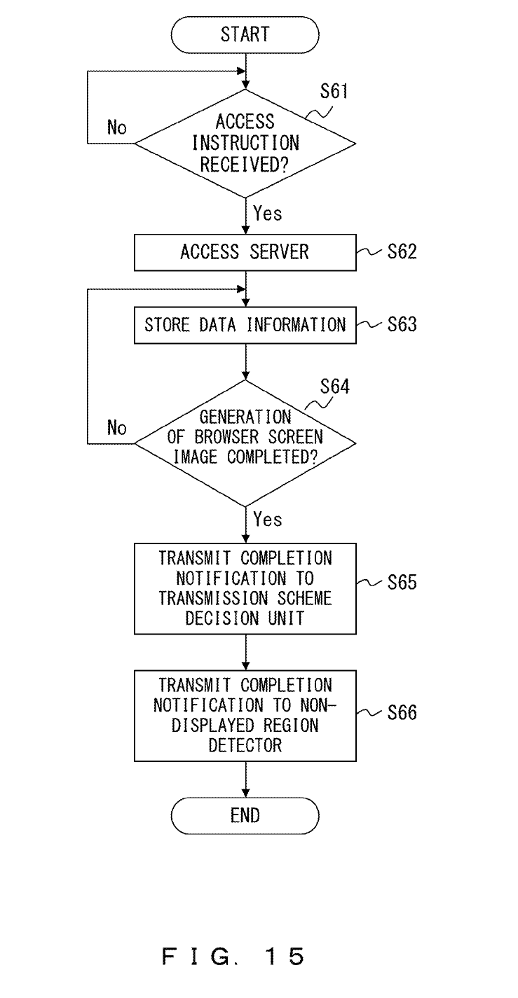

FIG. 15 is a flow chart illustrating a process of the Web browser 54. The process of the flow chart corresponds to S8 and S9 of FIG. 5.

In S61, the Web browser 54 waits for an access instruction transmitted from the execution decision unit 56. When the access instruction is received from the execution decision unit 56, the Web browser 54 accesses the Web service URL notified from the execution decision unit in S62. The URL is the same as the URL of the Web service requested by the terminal device 2. More specifically, the Web browser 41 of the terminal device 2 and the Web browser 54 of the gateway 3 request the same Web service.

In S63 and S64, the Web browser 54 receives service data corresponding to the requested Web service from the server 1. As illustrated in FIG. 6A, the Web browser 54 stores the data information indicating the data name, the data size, the acquired location, etc. of each data element of the received service data. The Web browser 54 generates a browser screen image corresponding to the requested Web service. The image generated in S63 and S64 is substantially the same as the browser screen image generated in the terminal device 2 when all service data is transmitted to the terminal device 2. More specifically, the Web browser 54 can generate substantially the same image as the browser screen image generated in the terminal device 2.

In S65, the Web browser 54 notifies the transmission scheme decision unit 59 of the completion of the generation of the browser screen image corresponding to the requested Web service. In S66, the Web browser 54 transmits, to the non-displayed region detector 58, a completion notification indicating the completion of the generation of the browser screen image corresponding to the requested Web service.

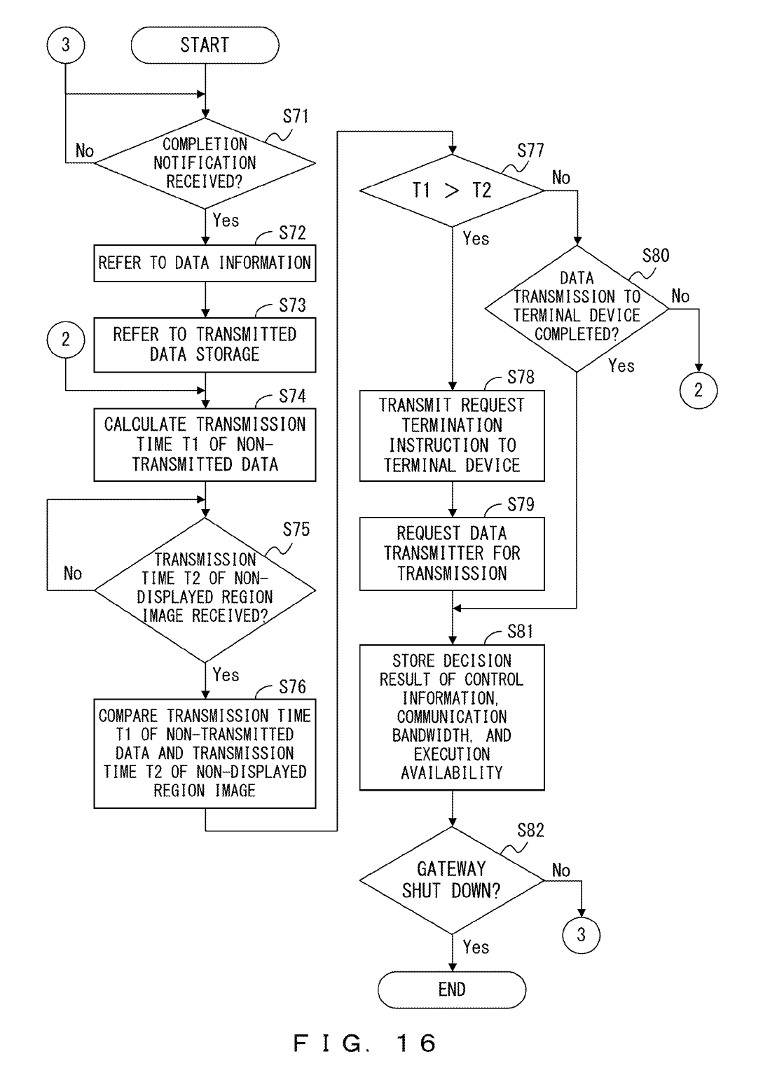

FIG. 16 is a flow chart illustrating a process of the transmission scheme decision unit 59. The process of the flow chart corresponds to S10, S12, S13, and S15 of FIG. 5.

In S71, the transmission scheme decision unit 59 waits for a completion notification transmitted from the Web browser 54. When the completion notification is received from the Web browser 54, the transmission scheme decision unit 59 refers to the data information created by the Web browser 54 to recognize the service data transmitted from the server 1 to the terminal device 2 in S72. The data information is created and stored in S64 illustrated in FIG. 15. In S73, the transmission scheme decision unit 59 refers to the transmitted data storage 52 to detect data already transmitted to the terminal device 2 (i.e. transmitted data) in the service data received from the server 1. An example of the transmitted data storage 52 is as illustrated in FIG. 6B.

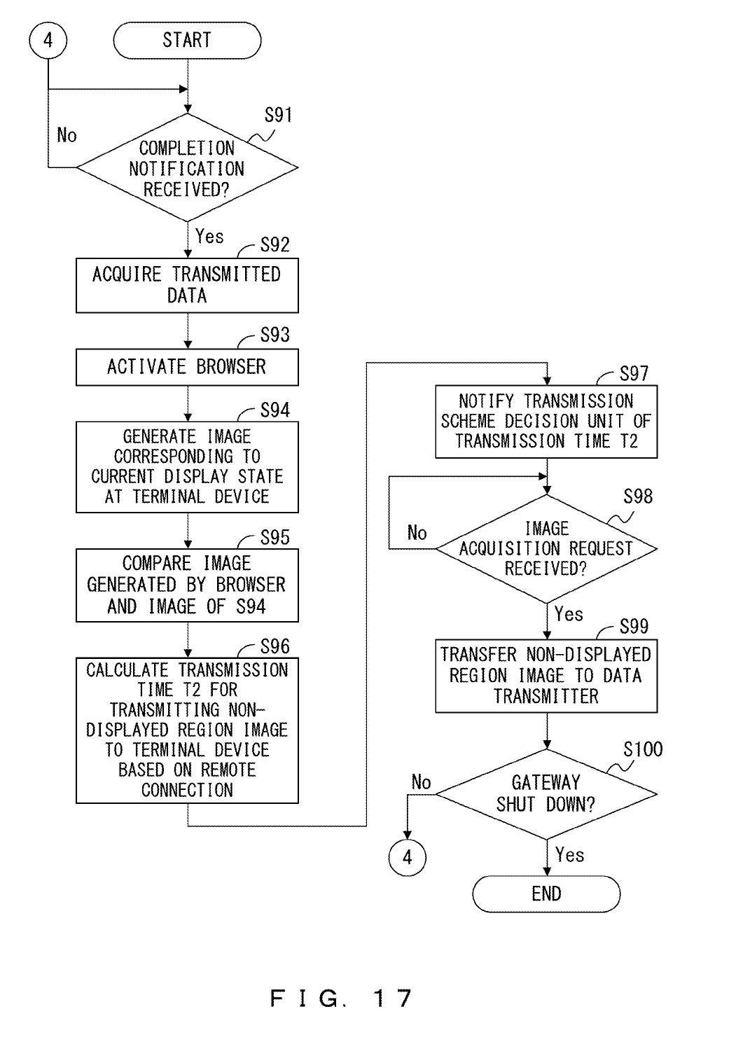

In S74, the transmission scheme decision unit 59 compares the service data transmitted from the server 1 to the terminal device 2 and the transmitted data to detect non-transmitted data that is not transmitted to the terminal device 2. The transmission scheme decision unit 59 calculates or estimates the transmission time T1 required for transmitting the non-transmitted data to the terminal device 2 based on the data size of the non-transmitted data. In S75, the transmission scheme decision unit 59 waits for a notification indicating the transmission time T2. The transmission time T2 denotes time required for transmitting the non-displayed region image data to the terminal device 2, and this will be described with reference to FIG. 17.

In S76 and S77, the transmission scheme decision unit 59 compares the transmission time T1 of the non-transmitted data and the transmission time T2 of the non-displayed region image data. If the transmission time T2 of the non-displayed region image data is shorter than the transmission time T1 of the non-transmitted data, the process of the transmission scheme decision unit 59 proceeds to S78. In this case, the data transmission based on the HTTP is switched to the image data transmission based on the remote connection. On the other hand, if the transmission time T2 of the non-displayed region image data is equal to or longer than the transmission time T1 of the non-transmitted data, the process of the transmission scheme decision unit 59 proceeds to S80. In this case, the data transmission based on the HTTP continues.

In S78, the transmission scheme decision unit 59 transmits a request termination instruction for terminating the Web browser to the terminal device 2. The screen selector 45 in the terminal device 2 receives the request termination instruction. In S79, the transmission scheme decision unit 59 provides a transmission request to the data transmitter 60.

In S80, the transmission scheme decision unit 59 determines whether all data elements in the service data transmitted from the server 1 to the terminal device 2 are transmitted to the terminal device 2. If there are data elements not transmitted to the terminal device 2, the process of the transmission scheme decision unit 59 returns to S74. More specifically, the transmission time T1 and the transmission time T2 are repeatedly compared until all data elements are transmitted to the terminal device 2. When the transmission time T2 becomes shorter than the transmission time T1, the data transmission based on the HTTP is switched to the image data transmission based on the remote connection at this point.

In S81, the transmission scheme decision unit 59 creates execution decision information and stores the execution decision information in the execution decision information storage 57. The execution decision information includes information indicating the execution availability for the destination URL, the terminal device information, and the communication bandwidth as illustrated in FIG. 8. In S82, the transmission scheme decision unit 59 monitors the start of a shutdown procedure of the gateway 3. More specifically, the transmission scheme decision unit 59 repeats the process of S71 to S81 until the shutdown procedure of the gateway 3 is started.

FIG. 17 is a flow chart illustrating a process of the non-displayed region detector 58. The process of the flow chart corresponds to S12 of FIG. 5.

In S91, the non-displayed region detector 58 waits for a completion notification transmitted from the Web browser 54. When the completion notification is received from the Web browser 54, the non-displayed region detector 58 acquires transmitted data that is already transmitted to the terminal device 2 from the transmitted data storage 52 in S92. An example of the transmitted data storage 52 is as illustrated in FIG. 6B.

In S93 and S94, the non-displayed region detector 58 newly activates the Web browser 54. The non-displayed region detector 58 causes the newly activated Web browser 54 to generate a screen image based on the transmitted data. This screen image is substantially the same as the screen image displayed in the terminal device 2 at this point (current screen in FIG. 9).

In S95, the non-displayed region detector 58 compares the image generated by the Web browser 54 of the gateway 3 based on the service data acquired from the server 1 and the image generated in S94. The image generated by the Web browser 54 is equivalent to the screen image corresponding to the Web service requested by the terminal device 2 (complete screen in FIG. 9). Therefore, the difference image between the two screen images indicates an image that is not displayed on the terminal device 2 at this point (i.e. non-displayed region image).

In S96, the non-displayed region detector 58 calculates or estimates the transmission time T2 required for transmitting the non-displayed region image (i.e. the difference image between the two screen images) to the terminal device 2 based on the remote connection. The transmission time T2 is calculated based on the data size of the non-displayed region image. In S97, the non-displayed region detector 58 notifies the transmission scheme decision unit 59 of the calculated transmission time T2. The information indicating the transmission time T2 is received in S75 of FIG. 16 and compared with the transmission time T1 in S76.

In S98, the non-displayed region detector 58 waits for an image acquisition request generated by the data transmitter 60. When the image acquisition request is received, the non-displayed region detector 58 transfers the non-displayed region image to the data transmitter 60 in S99. In S100, the non-displayed region detector 58 monitors the start of a shutdown procedure of the gateway 3. More specifically, the non-displayed region detector 58 repeats the process of S91 to S99 until the shutdown procedure of the gateway 3 is started.

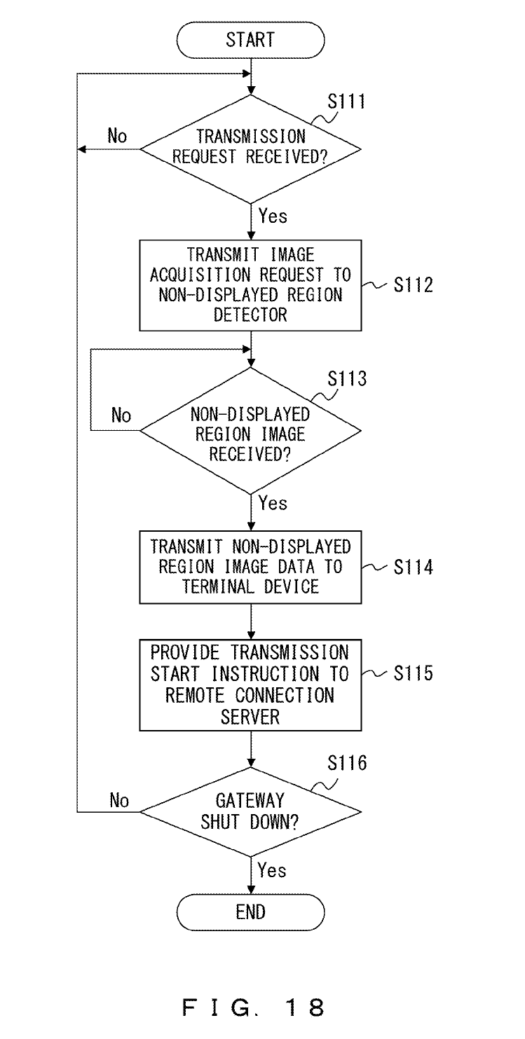

FIG. 18 is a flow chart illustrating a process of the data transmitter 60. The process of the flow chart corresponds to S19 of FIG. 5.

In S111, the transmitter 60 waits for a transmission request generated by the transmission scheme decision unit 59. When the transmission request is received from the transmission scheme decision unit 59, the data transmitter 60 transmits an image acquisition request to the non-displayed region detector 58 to acquire the non-displayed region image in S112.

In S113, the data transmitter 60 waits for the non-displayed region image generated by the non-displayed region detector 58. When the non-displayed region image is received from the non-displayed region detector 58, the data transmitter 60 transmits the non-displayed region image to the terminal device 2 based on the remote connection scheme in S114. In this case, the data transmitter 60 may convert the non-displayed region image received from the non-displayed region detector 58 into a data format of the remote connection scheme. The remote connection screen configuration unit 44 in the terminal device 2 receives the non-displayed region image data.

In S115, the data transmitter 60 provides a transmission start instruction to the remote connection server 55. As a result, the remote connection server 55 communicates with the remote connection client 43 of the terminal device 2 based on the remote connection scheme hereafter. In S116, the data transmitter 60 monitors the start of a shutdown procedure of the gateway 3. More specifically, the data transmitter 60 repeats the process of S111 to S115 until the shutdown procedure of the gateway 3 is started.

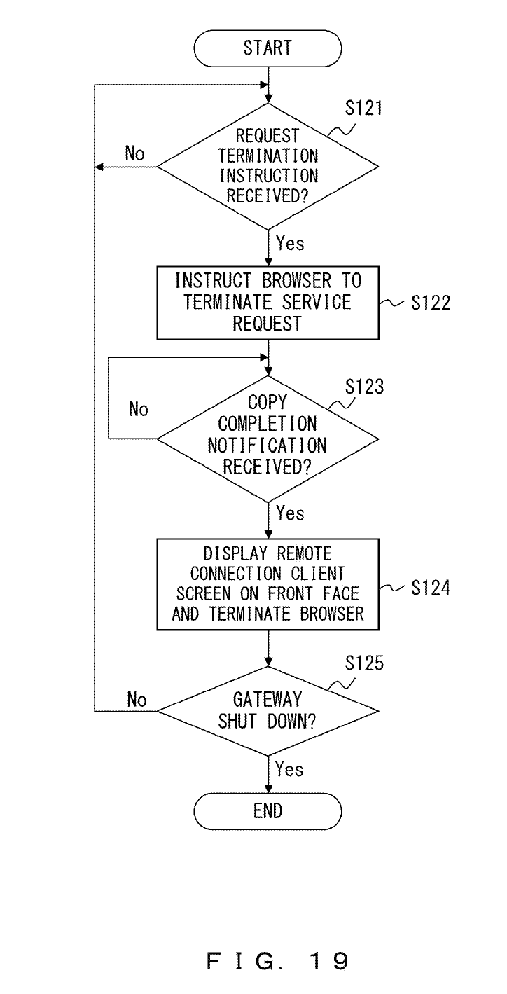

FIG. 19 is a flow chart illustrating a process of the screen selector 45. The process of the flow chart corresponds to S18 of FIG. 15.

In S121, the screen selector 45 waits for a request termination instruction generated by the transmission scheme decision unit 59. The request termination instruction is generated in S78 of FIG. 16. When the request termination instruction is received from the transmission scheme decision unit 59, the screen selector 45 instructs the Web browser 41 to terminate the Web service request in S122. As a result, the Web browser 41 terminates the operation of requesting the server 1 for the Web service. The Web browser 41 notifies the remote connection screen configuration unit 44 of the termination of the service request.

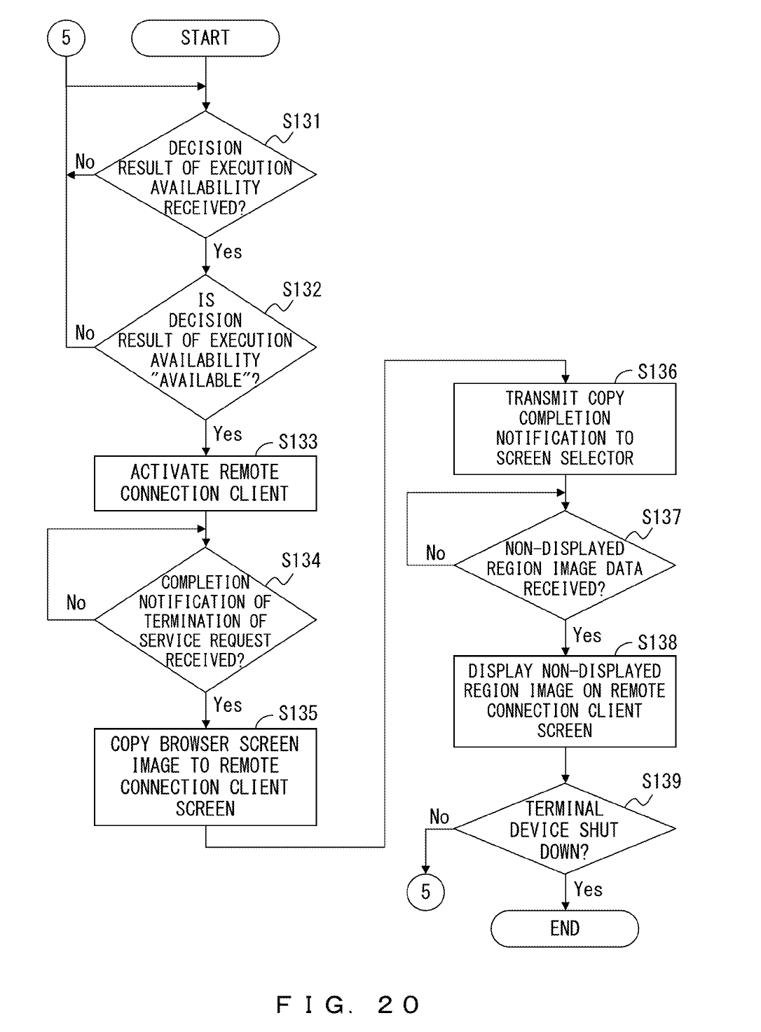

In S123, the screen selector 45 waits for a copy completion notification generated by the remote connection screen configuration unit 44. The copy completion notification is generated in S136 of FIG. 20 described later. When the copy completion notification is received from the remote connection screen configuration unit 44, the screen selector 45 sets the remote connection screen on the front face of the display screen in S124. As a result, the switch from the Web browser screen to the remote connection client screen is realized. The screen selector 45 then terminates the Web browser 41. In S125, the screen selector 45 monitors the start of a shutdown procedure of the terminal device 2. More specifically, the screen selector 45 repeats the process of S121 to S124 until the shutdown procedure of the terminal device 2 is started.

FIG. 20 is a flow chart illustrating a process of the remote connection screen configuration unit 44. The process of the flow chart corresponds to S17 and S20 of FIG. 5.

In S131 and S132, the remote connection screen configuration unit 44 waits for a decision result with respect to the execution availability of the remote connection from the gateway 3. The execution decision unit 56 generates the decision result in S55 illustrated in FIG. 14. If the decision result indicates “Available”, the process of the remote connection screen configuration unit 44 proceeds to S133. In S133, the remote connection screen configuration unit 44 activates the remote connection client 43. As a result, the remote connection client 43 of the terminal device 2 and the remote connection server 55 of the gateway 3 can communicate with each other based on the remote connection scheme.

In S134, the remote connection screen configuration unit 44 waits for a notification indicating the termination of the Web service request by the Web browser 41. When the notification is received, the remote connection screen configuration unit 44 copies the screen image of the Web browser to the remote connection screen in S135. The remote connection screen configuration unit 44 transmits a copy completion notification indicating the completion of the copy process to the screen selector 45 in S136. When the copy completion notification is received, the screen selector 45 sets the remote connection screen on the front face of the display screen in S124.

In S137, the remote connection screen configuration unit 44 waits for a non-displayed region image generated by the gateway 3. The non-displayed region image is generated by the non-displayed region detector 58 and transmitted by the data transmitter 60. When the non-displayed region image is received, the remote connection screen configuration unit 44 displays the non-displayed region image on the remote connection screen in S138. In this case, an image generated by the Web browser 41 is displayed on the remote connection screen. Therefore, the non-displayed region image is superimposed on the image of the Web browser.

In S139, the remote connection screen configuration unit 44 monitors the start of a shutdown procedure of the terminal device 2. More specifically, the remote connection screen configuration unit 44 repeats the process of S131 to S138 until the shutdown procedure of the terminal device 2 is started.

If it is determined in the gateway 3 that the remote connection will not be executed, S133 to S138 are not executed. In this case, the Web browser screen is not switched to the remote connection screen in the terminal device 2. More specifically, the terminal device 2 displays the screen image generated based on the service data received using the Web browser 41.

The gateway equipment and the communication control method according to other embodiments of the present invention will be described. The other embodiments described below are realized by adding some factors or changing some factors from the gateway equipment and the communication control method described with reference to FIGS. 1 to 20.

### FIRST EMBODIMENT

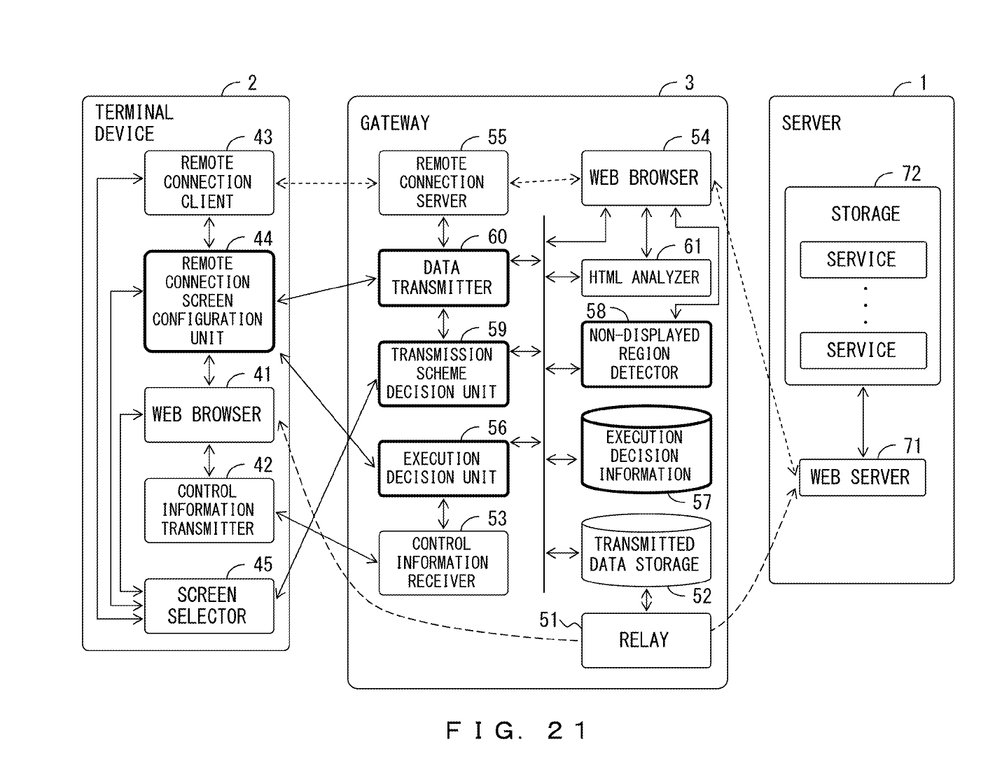

FIG. 21 is a diagram describing functions of the terminal device 2, the gateway 3, and the server 1 according to a first embodiment. The gateway 3 of the first embodiment includes an HTML analyzer 61 in addition to the functions illustrated in FIG. 4.

In the gateway 3, the Web browser 54 receives an HTML file (such as index.html, index.cgi, and index.shtml) from the server 1. This HTML file is substantially the same as the HTML file requested to the server 1 by the terminal device 2, as described above.

The HTML analyzer 61 analyzes the HTML file acquired by the Web browser 54 from the server 1. The HTML analyzer 61 analyzes whether the HTML file refers to data other than image data. Although not particularly limited, examples of the image data include a jpg file, a gif file, and a png file. Although not particularly limited, examples of the data other than the image data include an external file of JavaScript (such as .js file), Java Applet, video data (such as wmv file and mp4 file), audio data (such as wav file and mp3 file), and document data (such as pdf file and doc file).

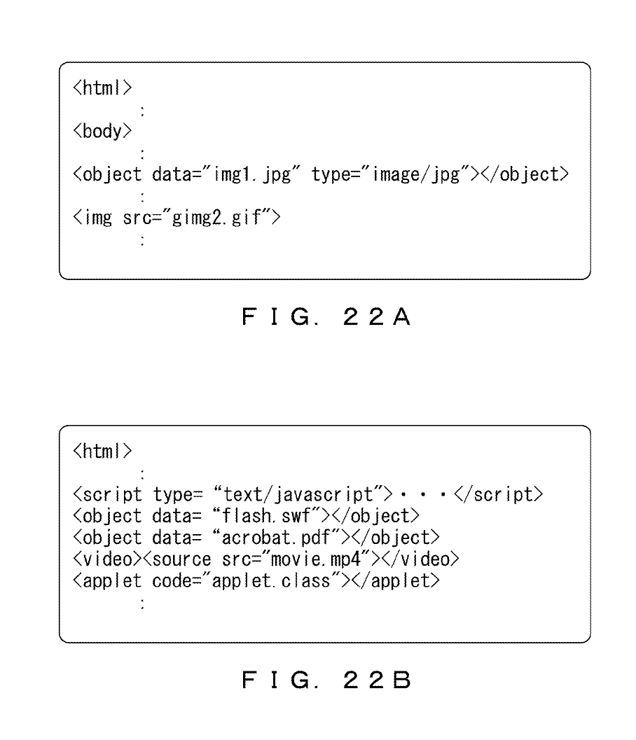

For example, an HTML file illustrated in FIG. 22A does not refer to data other than image data. On the other hand, an HTML file illustrated in FIG. 22B refers to data other than image data.

The time required for transmitting the image data from the gateway 3 to the terminal device 2 is substantially the same in the HTTP and in the remote connection scheme. More specifically, when the HTML file does not refer to data other than image data, the data transmission time from the gateway 3 to the terminal device 2 is substantially the same in the HTTP and in the remote connection. Therefore, the gateway 3 does not switch the data transmission scheme from the HTTP to the remote connection in this case. In this case, the Web browser 41 of the terminal device 2 continues the operation of receiving the HTML file from the server 1 based on the HTTP.

On the other hand, if the HTML file refers to data other than image data, it is expected that the time required for transmitting the image data generated based on the HTML file from the gateway 3 to the terminal device 2 through the remote connection is shorter than the time required for transmitting the HTML file from the gateway 3 to the terminal device 2 based on the HTTP. Therefore, in this case, the gateway 3 generates the image data from the HTML file and transmits the image data to the terminal device 2 based on the remote connection. The image data corresponds to (or is equivalent to) the non-displayed region image data illustrated in FIG. 11.

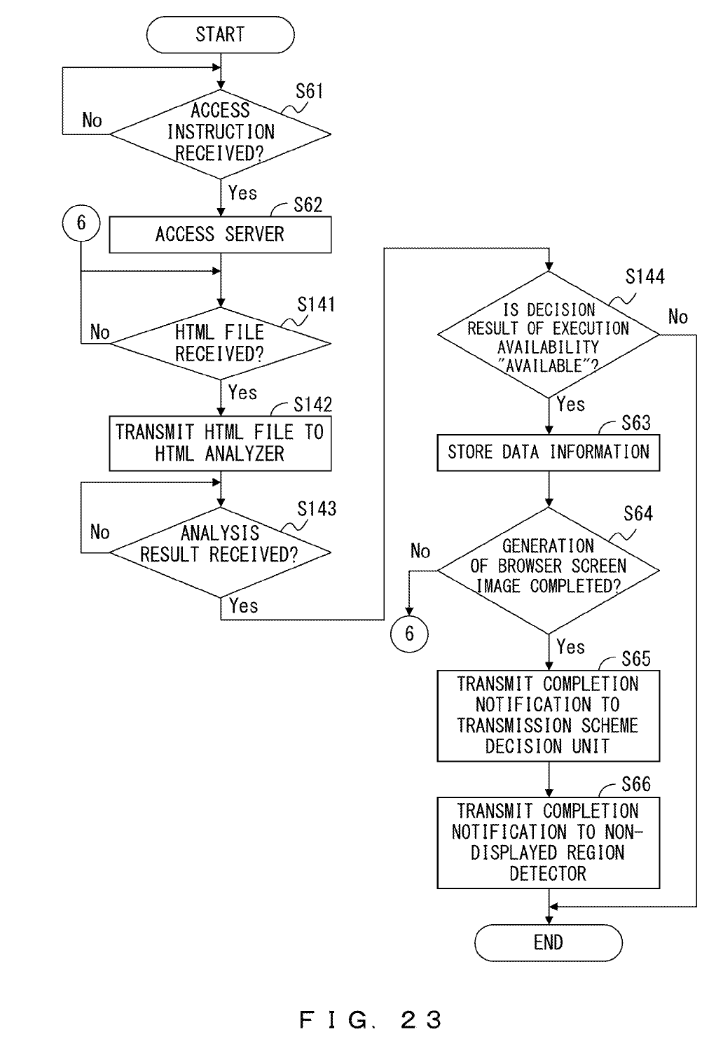

FIG. 23 is a flow chart illustrating a process of the Web browser 54 in the first embodiment. The description of the same processes in FIGS. 15 and 23 will not be repeated.

In S141, the Web browser 54 waits for an HTML file transmitted from the server 1. The HTML file is substantially the same as the file requested to the server 1 by the terminal device 2. When the HTML file is received from the server 1, the Web browser 54 transmits the HTML file to the HTML analyzer 61 in S142.

In S143 and S144, the Web browser 54 waits for a result of analysis by the HTML analyzer 61. The analysis result indicates whether the image data transmission based on the remote connection may be executed. If the analysis result indicates “Available”, the process of the Web browser 54 proceeds to S63. On the other hand, if the analysis result indicates “Not Available”, the process of the Web browser 54 ends.

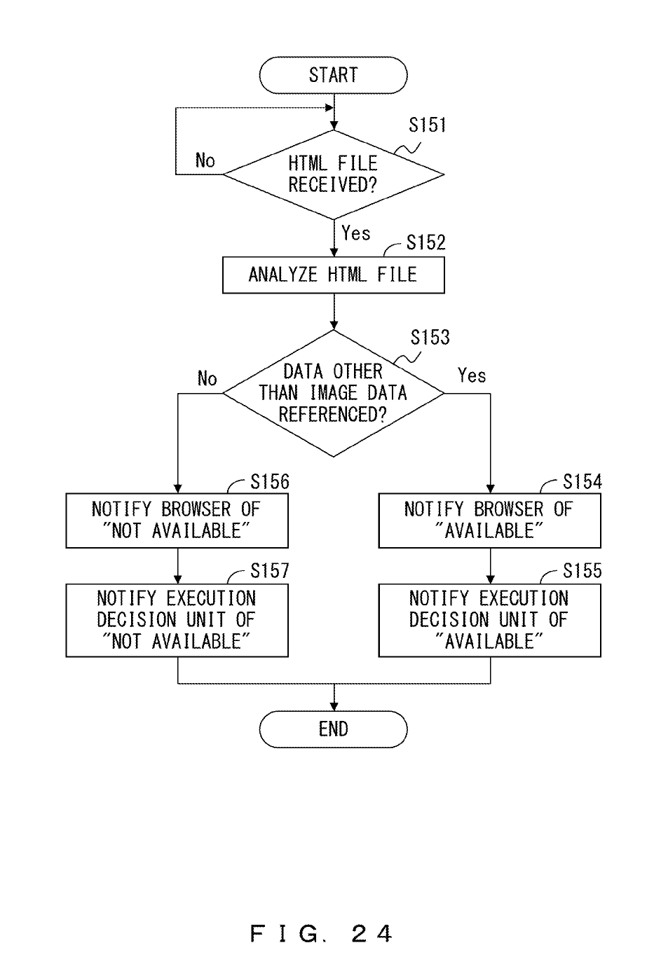

FIG. 24 is a flow chart illustrating a process of the HTML analyzer 61. The HTML analyzer 61 waits for an HTML file acquired by the Web browser 54 in S151. When the HTML file is received from the Web browser 54, the HTML analyzer 61 analyzes the HTML file in S152 and S153. In this embodiment, the HTML analyzer 61 determines whether the HTML file refers to data other than image data.

If the HTML file refers to data other than image data, the HTML analyzer 61 notifies the Web browser 54 and the execution decision unit 56 of “Analysis Result: Available” in S154 and S155. On the other hand, if the HTML file does not refer to data other than image data, the HTML analyzer 61 notifies the Web browser 54 and the execution decision unit 56 of “Analysis Result: Not Available” in S156 and S157. The analysis result indicates whether the image data transmission based on the remote connection may be executed. The Web browser 54 receives the analysis result in S143 illustrated in FIG. 23.

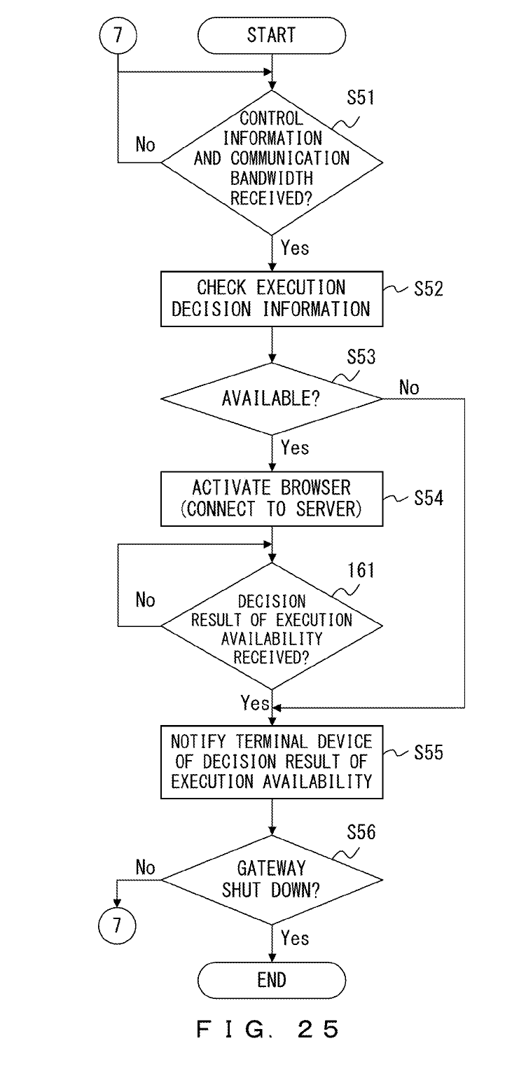

FIG. 25 is a flow chart illustrating a process of the execution decision unit 56 in the first embodiment. The description of the same processes in FIGS. 14 and 25 will not be repeated.

After activating the Web browser 54 in S54, the execution decision unit 56 waits for a result of analysis by the HTML analyzer 61 in S161. The analysis result indicates whether the image data transmission based on the remote connection may be executed as described with reference to FIG. 24. When the analysis result is received from the HTML analyzer 61, the execution decision unit 56 notifies the remote connection screen configuration unit 44 of the information indicating the execution availability in S55.

In this way, the gateway 3 of the first embodiment does not switch the data transmission scheme from the HTTP to the remote connection if the HTML file acquired from the server 1 does not refer to data other than image data. More specifically, if reduction in the transmission time is not expected even if the data transmission scheme is switched from the HTTP to the remote connection, the gateway 3 determines not to perform the remote connection without comparing the estimated transmission time based on the HTTP and the estimated transmission time based on the remote connection scheme. In this case, the gateway 3 does not execute the process of comparing the estimated transmission time based on the HTTP and the estimated transmission time based on the remote connection scheme, and the consumption of the resources of the gateway 3 is reduced.

### SECOND EMBODIMENT

The gateway 3 acquires data information of service data corresponding to a Web service when the Web service is requested from a terminal device to the server 1. The data information includes data names and data sizes of data elements included in the service data. The data information is used to decide whether to transmit the data related to the Web service to the terminal device based on the remote connection scheme. Therefore, if the gateway 3 stores data information corresponding to Web services provided from the server 1 to the terminal device in the past, the gateway 3 may use the data information to decide whether to execute the remote connection for a new Web service request.

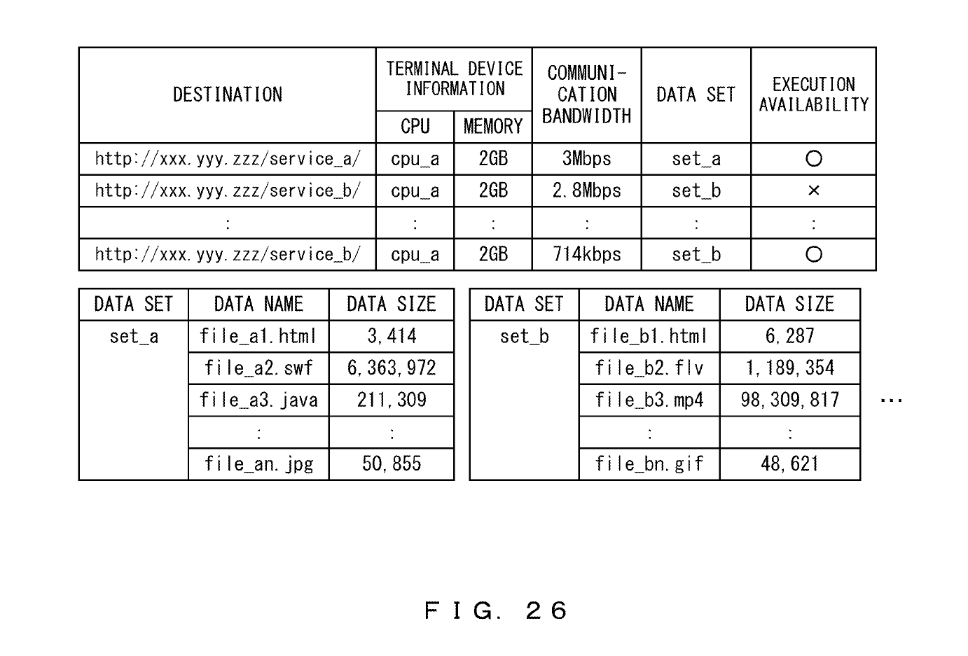

In the gateway 3 of the second embodiment, the Web browser 54 stores the data information of the service data corresponding to the Web service acquired from the server in the execution decision information storage 57 in association with execution decision information. For example, in addition to the destination URL, the terminal device information, the communication bandwidth, and the execution availability, a data set identifier is recorded in the execution decision information as illustrated in FIG. 26. The data set identifier may identifies the URL of the Web service. The data information (i.e. data name and data size) of the service data for providing the Web service is stored in association with the data set identifier. In the example illustrated in FIG. 26, data names (file_a1.html to file_an.jpg) and data sizes of the data elements are stored in association with the data set identifier for identifying a service a.

It is assumed here that the execution decision information storage 57 of the gateway 3 stores the execution decision information illustrated in FIG. 26. It is also assumed that the service a is requested from a terminal device to the server 1. In this case, the gateway 3 can use a data set identifier set_a corresponding to the requested service a to acquire the data names and the data sizes of the data elements included in the service data for providing the service a. In this case, the Web browser 54 does not have to analyze the data names and the data sizes of the data elements included in the service data corresponding to the service a. Therefore, according to the second embodiment, the load of the Web browser is reduced.

### THIRD EMBODIMENT

In the configuration illustrated in FIG. 4, the data transmitter 60 transmits the non-displayed region image data to the remote connection screen configuration unit 44 of the terminal device 2. In a third embodiment, the remote connection server 55 provides the function of the data transmitter 60 illustrated in FIG. 4. More specifically, the remote connection server 55 of the third embodiment can transmit the non-displayed region image data to the remote connection screen configuration unit 44 of the terminal device 2.

According to the third embodiment, the configuration of the gateway 3 may be simplified. Furthermore, notifications transferred between the data transmitter 60 and the remote connection server 55 in the configuration illustrated in FIG. 4 are not necessary.

### OTHER EMBODIMENTS

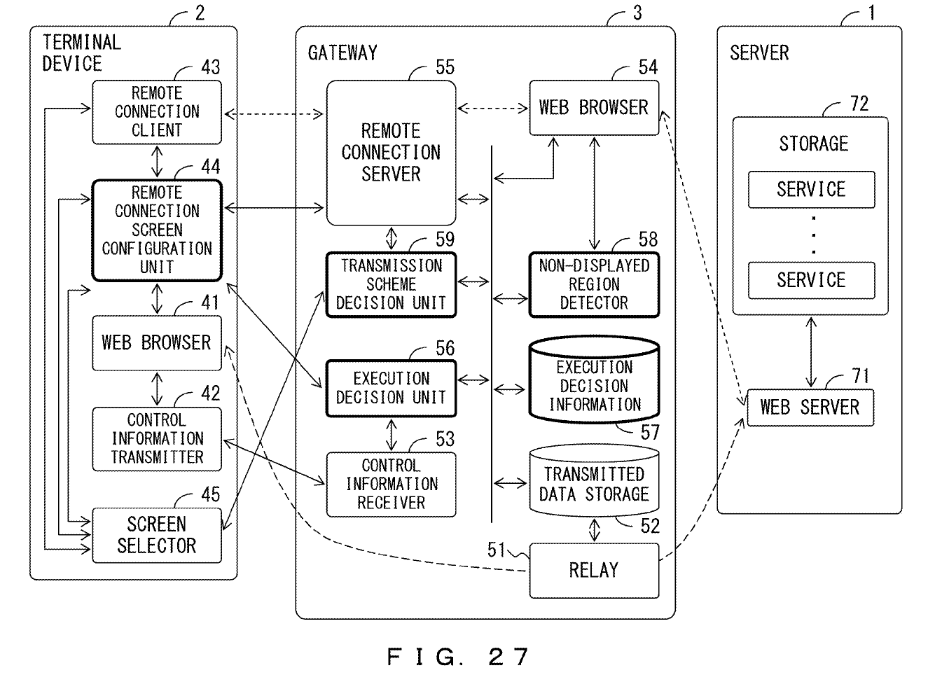

In the embodiments described with reference to FIGS. 2A to 27, whether to transmit data through the remote connection is determined based on the comparison between the transmission time of the non-transmitted data and the transmission time of the non-displayed region image (or the comparison between the data size of the non-transmitted data and the data size of the non-displayed region image). However, the gateway 3 of an embodiment of the present invention may take other factors into account to determine whether to transmit data based on the remote connection.

For example, a cost of displaying the non-transmitted data in the terminal device 2 and a cost of displaying the non-displayed region image on the terminal device 2 may be compared. The cost of displaying the non-transmitted data in the terminal device 2 includes a cost of a process of transmitting the non-transmitted data from the gateway 3 to the terminal device 2 and a cost of a process of generating an image based on the non-transmitted data in the terminal device 2. The cost of the process of generating the image based on the non-transmitted data in the terminal device 2 depends on the resources of the terminal device 2.

In this case, the resources of the terminal device 2 are referenced to determine whether to use the remote connection in the communication between the gateway 3 and the terminal device 2. Therefore, in this case, the execution decision unit 56 may also refer to the “Terminal Device Information” of the execution decision information illustrated in FIG. 8 or 26 in addition to the transmission time of the non-transmitted data and the transmission time of the non-displayed region image to determine whether to perform the remote connection.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. Communication equipment arranged between a terminal device and a server, the communication equipment comprising:
a detector configured to detect transmitted data that is transmitted from the communication equipment to the terminal device and non-transmitted data that is not transmitted from the communication equipment to the terminal device, from service data transmitted from the server to the terminal device through the communication equipment;
a first calculator configured to calculate a first cost of transmitting the non-transmitted data to the terminal device;
a second calculator configured to calculate a second cost of transmitting, to the terminal device, a difference image between an image corresponding to the service data and an image corresponding to the transmitted data; and
a transmission scheme decision unit configured to transmit the non-transmitted data to the terminal device when the second cost is equal to or greater than the first cost and transmit the difference image to the terminal device when the second cost is smaller than the first cost.

2. The communication equipment according to claim 1, wherein
the first calculator calculates the first cost based on a data size of the non-transmitted data; and
the second calculator calculates the second cost based on a data size of the difference image.

3. The communication equipment according to claim 2, further comprising
a bandwidth estimator configured to estimate a communication bandwidth between the terminal device and the communication equipment, wherein
the first calculator calculates, as the first cost, time required for transmitting the non-transmitted data to the terminal device based on the data size of the non-transmitted data and the communication bandwidth, and
the second calculator calculates, as the second cost, time required for transmitting the difference image to the terminal device based on the data size of the difference image and the communication bandwidth.

4. The communication equipment according to claim 1, further comprising
a request unit configured to specify a service requested from the terminal device to the server and request the server for the specified service to acquire the same data as the service data, wherein
the detector detects the non-transmitted data based on the data acquired by the request unit and based on the transmitted data.

5. The communication equipment according to claim 4, wherein
the second calculator generates a complete image corresponding to the service requested from the terminal device to the server based on the data acquired by the request unit, generates a current image corresponding to a display state of the terminal device based on the transmitted data, and generates the difference image by comparing the complete image and the current image.

6. The communication equipment according to claim 1, further comprising
an analyzer configured to decide whether the service data refers to data other than image data, and
the transmission scheme decision unit transmits the non-transmitted data to the terminal device regardless of the first and second costs when the service data does not refer to data other than image data.

7. A communication control method performed in communication equipment arranged between a terminal device and a server, the communication control method comprising:
detecting transmitted data that is transmitted from the communication equipment to the terminal device and non-transmitted data that is not transmitted from the communication equipment to the terminal device, from service data transmitted from the server to the terminal device through the communication equipment;
calculating a first cost of transmitting the non-transmitted data to the terminal device;
calculating a second cost of transmitting, to the terminal device, a difference image between an image corresponding to the service data and an image corresponding to the transmitted data; and
transmitting the non-transmitted data to the terminal device when the second cost is equal to or greater than the first cost and transmitting the difference image to the terminal device when the second cost is smaller than the first cost.

8. A communication control method performed in a communication system in which service data is transmitted from a server to a terminal device through a gateway according to a request from the terminal device, wherein
the gateway detects, from the service data, transmitted data that is transmitted from the gateway to the terminal device and non-transmitted data that is not transmitted from the gateway to the terminal device,
the gateway calculates a first cost of transmitting the non-transmitted data to the terminal device,
the gateway calculates a second cost of transmitting, to the terminal device, a difference image between an image corresponding to the service data and an image corresponding to the transmitted data,
the gateway transmits the non-transmitted data to the terminal device when the second cost is equal to or greater than the first cost, and transmits the difference image to the terminal device when the second cost is smaller than the first cost,
the terminal device generates an image corresponding to the transmitted data, and
the terminal device superimposes the difference image transmitted from the gateway on the generated image to display the images.

9. Communication equipment arranged between a terminal device and a server, the communication equipment comprising a processor, wherein
the processor performs a communication control method comprising:
detecting transmitted data that is transmitted from the communication equipment to the terminal device and non-transmitted data that is not transmitted from the communication equipment to the terminal device, from service data transmitted from the server to the terminal device through the communication equipment;
calculating a first cost of transmitting the non-transmitted data to the terminal device;
calculating a second cost of transmitting, to the terminal device, a difference image between an image corresponding to the service data and an image corresponding to the transmitted data; and
transmitting the non-transmitted data to the terminal device when the second cost is equal to or greater than the first cost and transmitting the difference image to the terminal device when the second cost is smaller than the first cost.
